(19) United States
(12) Patent Application Publication
(10) Pub. No.: US 2026/0187807 A1
(43) Pub. Date: Jul. 2, 2026

(54) PANOPTIC 4D POINT CLOUD SEGMENTATION

(71) Applicant: NVIDIA Corporation, Santa Clara, CA (US)

(72) Inventors: Yushan Zhang, Linkoping (SE); Aljosa Osep, Pittsburgh, PA (US); Tim Meinhardt, München (DE); Laura Leal-Taixe, Florence (IT)

(21) Appl. No.: 19/433,227

(22) Filed: Dec. 26, 2025

Related U.S. Application Data
(60) Provisional application No. 63/739,482, filed on Dec. 27, 2024.

(51) Int. Cl. G06T 7/10

(52) U.S. Cl. CPC G06T 7/10; G06T 2207/10016; G06T 2207/10028; G06T 2207/20081; G06T 2207/20084

(57) ABSTRACT

Neural network architectures and machine learning techniques for panoptic segmentation of 4D point clouds. Systems and methods are disclosed that generate a dataset of labeled (i.e., segmented) 4D point clouds and use the generated dataset to train a neural network to perform zero-shot segmentation of 4D point clouds. In one or more embodiments, generating the training dataset leverages vision foundation models to generate temporally consistent pseudo-labels from multi-modal video and point cloud sequences. In one or more embodiments, one or more neural networks are trained to perform zero-shot segmentation of 4D point clouds, facilitating object detection, tracking, and recognition in dynamic environments, e.g., for applications in autonomous vehicles and robotics.

### CROSS-REFERENCE TO RELATED APPLICATIONS

This application claims the benefit of U.S. Provisional Application No. 63/739,482, filed Dec. 27, 2024, which is hereby incorporated by reference in its entirety.

### BACKGROUND

LiDAR, which stands for Light Detection and Ranging, is a remote sensing technology that measures distances by emitting laser pulses and recording the time it takes for each pulse to reflect off objects and return to the sensor. By calculating the time of flight for each pulse, LiDAR can generate high-resolution three-dimensional point clouds, which can be used, e.g., to represent an environment.

LiDAR technology has become an integral component in autonomous systems, such as self-driving vehicles and autonomous robots, due to its ability to generate high-resolution 3D point cloud representations of the surrounding environment under diverse environmental conditions. These systems rely on perception algorithms to segment, classify, and track objects within representations of their surroundings to enable safe and effective navigation. However, existing approaches to LiDAR-based segmentation face significant limitations, particularly in the context of multi-scan, temporally coherent segmentation. Current methods for training segmentation models often rely on manually labeled datasets, which are labor-intensive to produce and constrained to predefined object classes. This restricts scalability and adaptability in real-world environments where autonomous systems encounter a wide variety of objects. Furthermore, traditional multi-object tracking methods often decouple detection and association, leading to fragmented object tracks in scenarios that involve occlusion or rapid motion. Zero-shot segmentation methods—which rely on auxiliary information to be able to perform inferencing tasks on data that the models have not been previously trained on or exposed to—have emerged as a promising alternative, leveraging vision foundation models for pre-training and enabling segmentation of objects without explicit training data. However, these methods are limited to single-scan segmentation and fail to provide the temporal consistency required for interpreting sensory data in a 4D continuum.

### BRIEF DESCRIPTION OF THE DRAWINGS

Subject matter of the present disclosure is described in detail below with reference to the attached drawing figures. Features described and/or illustrated herein can be used alone and/or combined in different combinations. The attached drawings illustrate the following:

FIG. 1 is a block diagram illustrating a training framework for generating a proxy dataset and using the proxy dataset to train a zero-shot 4D panoptic segmentation model, in accordance with one or more embodiments.

FIG. 2A is a flow diagram illustrating a method for labeling objects in 4D point clouds, in accordance with one or more embodiments.

FIG. 2B is a block diagram illustrating a system for generating labeled 4D point cloud clips, in accordance with one or more embodiments.

FIG. 2C is a block diagram illustrating processing of a 4D point cloud clip paired with a corresponding set of video clips to generate a labeled 4D point cloud clip, in accordance with one or more embodiments.

FIG. 2D is a block diagram illustrating a system for generating full-length labeled 4D point cloud, in accordance with one or more embodiments.

FIG. 3A is a flow diagram illustrating a method for training a 4D panoptic segmentation model, in accordance with one or more embodiments.

FIG. 3B is a flow diagram illustrating a method for performing 4D panoptic segmentation, in accordance with one or more embodiments.

FIG. 3C is a block diagram illustrating a system for 4D panoptic point cloud segmentation, in accordance with one or more embodiments.

FIG. 4 illustrates an example parallel processing unit (“PPU”), suitable for use in implementing one or more embodiments.

FIG. 5A illustrates a processing system, implemented using the PPU of FIG. 4, suitable for use in implementing one or more embodiments.

FIG. 5B illustrates an example system in which various architectures and/or functionality may be implemented, according to one or more embodiments.

FIG. 5C illustrates an example system suitable for training and utilizing a machine learning model, according to one or more embodiments.

FIG. 6A is an illustration of an example autonomous vehicle, in accordance with one or more embodiments.

FIG. 6B is an example of camera locations and fields of view for the example autonomous vehicle of FIG. 6A, in accordance with one or more embodiments.

FIG. 6C is a block diagram of an example system architecture for the example autonomous vehicle of FIG. 6A, in accordance with one or more embodiments.

FIG. 6D is a system diagram for communication between cloud-based server(s) and the example autonomous vehicle of FIG. 6A, in accordance with one or more embodiments.

### DETAILED DESCRIPTION

Systems and methods are disclosed that relate to spatiotemporal scene understanding from 4D data, and in particular, to zero-shot 4D panoptic segmentation for object detection, tracking, and recognition. Systems and methods are disclosed that utilize neural network architectures and machine learning techniques to generate a dataset of labeled (i.e., segmented) 4D point clouds and to use the generated dataset to train a neural network to perform zero-shot segmentation of 4D point clouds. In one or more embodiments, generating the training dataset leverages vision foundation models to generate temporally consistent pseudo-labels from multi-modal video and point cloud sequences. In at least one embodiment, objects are first tracked and segmented in short video clips to provide video-space masks, each of which is annotated with a semantic feature, the video-space masks are subsequently projected (“lifted”) into the 4D space, and overlapping masks in the 4D space are flattened to ensure each 4D point is assigned to a single object instance. In at least one embodiment, masks from overlapping temporal windows (i.e., corresponding to the short video clips) are matched and merged to ensure consistent instance identities and semantic features across an entire 4D sequence. In one or more embodiments, training the neural network to perform zero-shot segmentation of 4D point clouds utilizes a composite loss that includes component losses for objectness (whether the model properly identifies the existence of object), segmentation (how accurately the model defines identified objects), and tokenization (how accurately the model assigns meaningful characteristics to identified objects).

According to a first aspect, a method for training one or more neural networks to label object instances in a 4D point cloud is provided. The method includes obtaining sample 4D point clouds, each respective sample 4D point cloud representing a respective scene for a respective period, labeling the sample 4D point clouds with target labels, and training a segmentation model. Training the segmentation includes performing, for one or more training iterations: generating predicted labels using the one or more neural networks based on a sample 4D point cloud, computing one or more losses based on the predicted labels and the target labels, and updating, based on the one or more losses, one or more parameters of the one or more neural networks.

In at least one embodiment of the method according to the first aspect, the labeling the sample 4D point clouds with target labels includes, for a respective sample 4D point cloud: (i) temporally partitioning the 4D point cloud into a plurality of overlapping windows, (ii) performing, for each respective window of multiple windows of the plurality of overlapping windows: segmenting one or more video clips corresponding to the respective window to generate one or more sets of video space masks for the respective window, the one or more video clips representing the scene represented by the respective sample 4D point cloud, and generating 4D point cloud masks for the respective window, the generating the 4D point cloud masks comprising extracting the one or more sets of video space masks from a video space to a 4D point cloud space corresponding to the 4D point cloud, and (iii) generating the target labels, the generating the target labels comprising correlating 4D point cloud masks for single object instances across the multiple windows.

In at least one embodiment of the method according to the first aspect, the performing, for each respective window of multiple windows of the plurality of overlapping windows, further comprises extracting semantic features for one or more video space masks of the one or more sets of video space masks for the respective window, and the target labels include embedding vectors corresponding to single object instances formed by averaging extracted semantic features across the multiple windows.

In at least one embodiment of the method according to the first aspect, the extracting the video space masks to the 4D point cloud space comprises projecting each mask into the coordinate frame of the 4D point cloud using calibration data associated with one or more LiDAR sensors via which data for the 4D point cloud was obtained and calibration data associated with one or more cameras via which the one or more video clips were obtained.

In at least one embodiment of the method according to the first aspect, the generating the 4D LiDAR point cloud masks for the respective window further includes refining extracted masks by applying density-based spatial clustering.

In at least one embodiment of the method according to the first aspect, the generating the 4D LiDAR point cloud masks for the respective window further includes flattening overlapping masks.

In at least one embodiment of the method according to the first aspect, the flattening overlapping masks includes ranking masks according to a number of labeled points to establish a mask hierarchy.

In at least one embodiment of the method according to the first aspect, the correlating 4D point cloud masks for single object instances across the multiple windows includes applying a linear assignment solver to match object instances between overlapping windows based on spatial overlap and semantic similarity.

In at least one embodiment of the method according to the first aspect, the embedding vectors corresponding to single object instances are vocabulary-agnostic semantic feature vectors produced by a vision-language encoder.

In at least one embodiment of the method according to the first aspect, the one or more neural networks include: a 4D encoder-decoder network to process 4D point clouds and produce feature tensors, and a transformer decoder to process learnable queries, based on the feature tensors, to generate the predicted labels.

In at least one embodiment of the method according to the first aspect, the predicted labels comprise binary segmentation masks and corresponding feature embeddings.

In at least one embodiment of the method according to the first aspect, the 4D panoptic segmentation model includes the 4D encoder-decoder network, the transformer decoder, and a class vocabulary encoder to process a class vocabulary and generate class embeddings.

In at least one embodiment of the method according to the first aspect, the 4D panoptic segmentation model further includes a projection and semantic matching configured to project the binary segmentation masks onto 4D point clouds and to perform cosine similarity scoring between object instance feature embeddings and class embeddings.

In at least one embodiment of the method according to the first aspect, the method is performed by at least one of: a system for performing simulation operations; a system for performing simulation operations to test or validate autonomous machine applications; a system for performing digital twin operations; a system for performing light transport simulation; a system for rendering graphical output; a system for performing deep learning operations; a system for performing generative operations using a large language model (LLM); a system for performing generative operations using a vision language model (VLM); a system for performing generative operations using a multi-modal language model; a system implemented using an edge device; a system for generating or presenting virtual reality (VR) content; a system for generating or presenting augmented reality (AR) content; a system for generating or presenting mixed reality (MR) content; a system incorporating one or more Virtual Machines (VMs); a system implemented at least partially in a data center; a system for performing hardware testing using simulation; a system for synthetic data generation; a collaborative content creation platform for 3D assets; a system implemented at least partially using cloud computing resources; a system using or deploying one or more inference microservices; or a system that incorporates one or more machine learning models deployed in a service or microservice along with an OS-level virtualization package.

According to a second aspect, a system is provided that includes one or more processors to perform panoptic segmentation of 4D point clouds using one or more neural networks. The neural networks are trained, at least in part, by: obtaining sample 4D point clouds, each respective sample 4D point cloud representing a respective scene for a respective period, labeling the sample 4D point clouds with target labels, performing, for one or more training iterations: generating predicted labels using the one or more neural networks based on a sample 4D point cloud, computing one or more losses based on the predicted labels and the target labels, and updating, based on the one or more losses, parameters of the one or more neural networks. The system additionally includes one or more memories to store parameters corresponding to the one or more neural networks.

In at least one embodiment of the system according to the second aspect, the labeling the sample 4D point clouds with target labels comprises, for a respective sample 4D point cloud: (i) temporally partitioning the 4D point cloud into a plurality of overlapping windows, (ii) performing, for each respective window of multiple windows of the plurality of overlapping windows: segmenting one or more video clips corresponding to the respective window to generate one or more sets of video space masks for the respective window, the one or more video clips representing the scene represented by the respective sample 4D point cloud, and generating 4D point cloud masks for the respective window, the generating the 4D point cloud masks comprising lifting the one or more sets of video space masks from a video space to a 4D point cloud space corresponding to the 4D point cloud, and (iii) generating the target labels, the generating the target labels comprising correlating 4D point cloud masks for single object instances across the multiple windows.

In at least one embodiment of the system according to the second aspect, the performing, for each respective window of multiple windows of the plurality of overlapping windows further includes extracting semantic features for one or more video space masks of the one or more sets of video space masks for the respective window, and the target labels include embedding vectors corresponding to single object instances formed by averaging extracted semantic features across the multiple windows.

In at least one embodiment of the system according to the second aspect, the one or more neural networks include a 4D encoder-decoder network to process 4D point clouds and produce feature tensors and a transformer decoder to process learnable queries, based on the feature tensors, to generate the predicted labels.

According to a third aspect, or more processors are provided that include one or more arithmetic logic units (ALUs) to train one or more neural networks, at least in part, by: obtaining sample 4D point clouds, each respective sample 4D point cloud representing a respective scene for a respective period, labeling the sample 4D point clouds with target labels, and training a panoptic 4D segmentation model. Training the panoptic 4D segmentation model includes performing, for one or more training iterations: generating predicted labels using the one or more neural networks based on a sample 4D point cloud, computing one or more losses based on the predicted labels and the target labels, and updating, based on the one or more losses, parameters of the one or more neural networks.

In at least one embodiment of the one or more processors according to the third aspect, the labeling the sample 4D point clouds with target labels includes, for a respective sample 4D point cloud: (i) temporally partitioning the 4D point cloud into a plurality of overlapping windows, (ii) performing, for each respective window of multiple windows of the plurality of overlapping windows: segmenting one or more video clips corresponding to the respective window to generate one or more sets of video space masks for the respective window, the one or more video clips representing the scene represented by the respective sample 4D point cloud, and generating 4D point cloud masks for the respective window, the generating the 4D point cloud masks comprising lifting the one or more sets of video space masks from a video space to a 4D point cloud space corresponding to the 4D point cloud, and (iii) generating the target labels, the generating the target labels comprising correlating 4D point cloud masks for single object instances across the multiple windows.

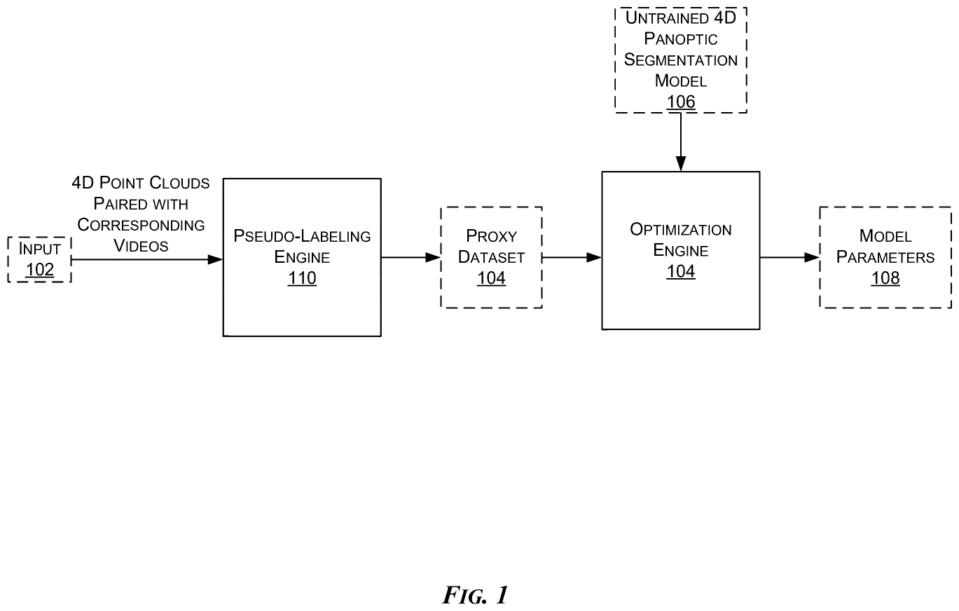

FIG. 1 is a block diagram illustrating a training framework 100 for generating a proxy dataset and using the proxy dataset to train a zero-shot 4D panoptic segmentation model, in accordance with one or more embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories.

FIG. 1 illustrates a training framework 100 for generating a proxy dataset 104 and using the proxy dataset 104 to train a zero-shot 4D panoptic segmentation model. The framework includes a pseudo-labeling engine 110, which receives input 102 in the form of 4D point clouds paired with sets of corresponding videos and generates a proxy dataset 104 as output, and an optimization engine 120, which receives input in the form of the proxy dataset 104 and an untrained 4D panoptic segmentation model 106 and generates output in the form of a set of model parameters 108 of a trained zero-shot 4D panoptic segmentation model.

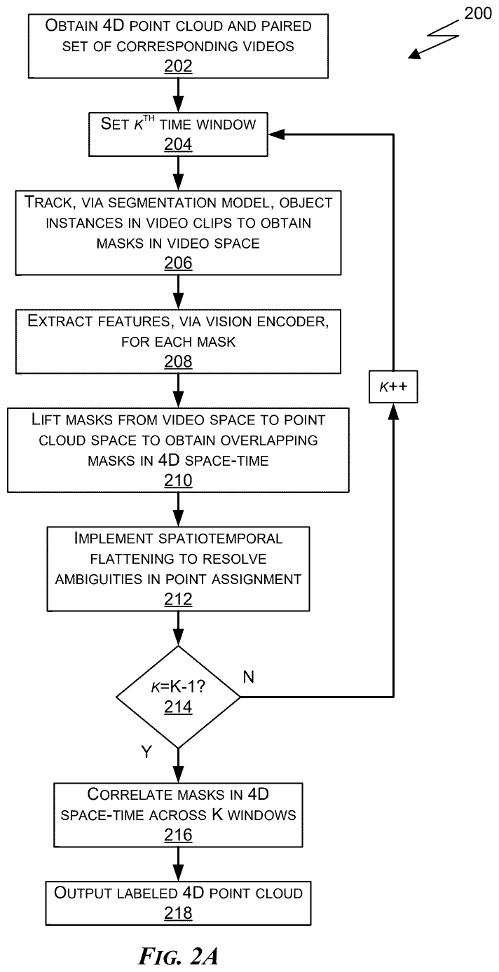

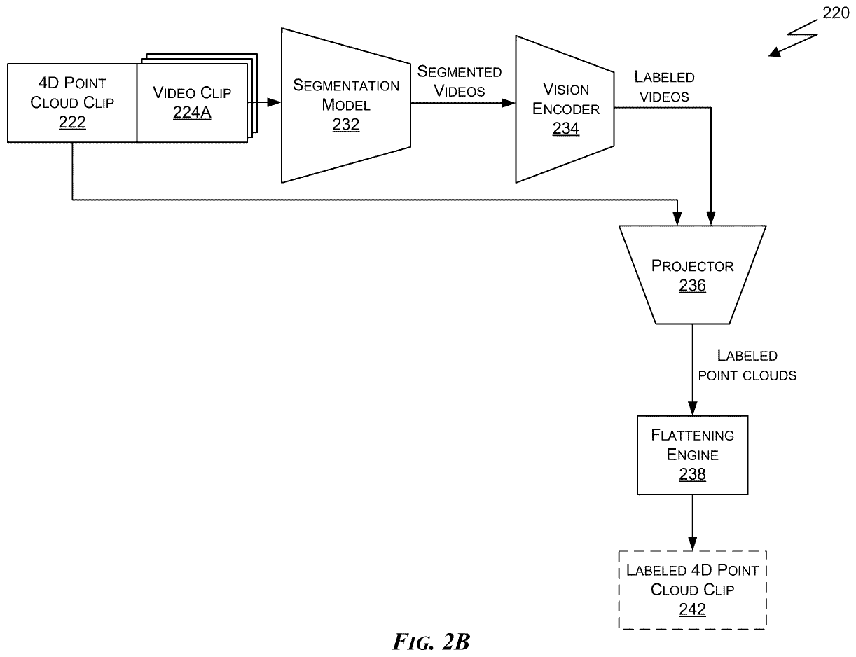

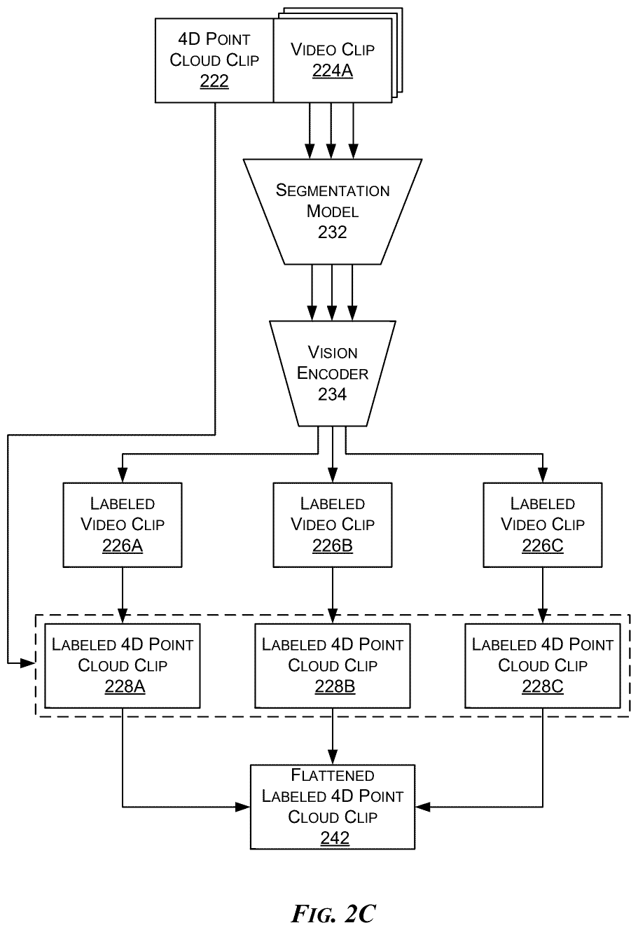

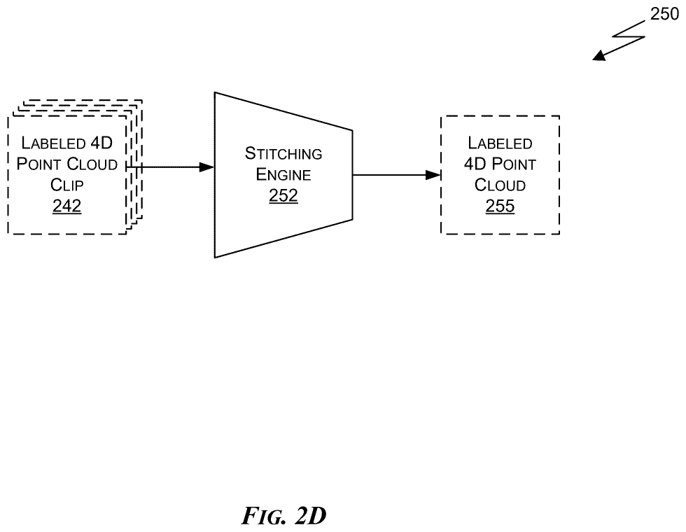

Pseudo-labeling engine 110 generates temporally consistent object labels for 4D point clouds. In at least one embodiment, each object label is a tuple including (i) a mask (e.g., a binary segmentation mask) that selects specific points in a 4D point cloud that belong to a specific object or region of interest, (ii) an object identifier (e.g., a natural number) that uniquely identifies the specific object or region of interest, and (iii) a semantic feature (e.g., an embedding vector) that assigns class labels and/or other meaningful information to the points that belong to the specific object or region of interest. In at least one embodiment, pseudo-labeling engine 110 generates temporally consistent object labels for 4D point clouds by performing method 200 of FIG. 2A for each 4D point cloud. In at least one embodiment, pseudo-labeling engine 110 includes both the system 220 for generating labeled 4D point cloud clips of FIG. 2B and the system 250 for generating full-length labeled 4D point clouds of FIG. 2D.

In at least one embodiment, pseudo-labeling engine 110 generates the object labels via a two stage process. In a first, track-lift-flatten stage, pseudo-labeling engine 110 operates on relatively short video clips, each corresponding a temporal slice of a full-length video (i.e., to a “window”). During the track-lift-flatten stage, pseudo-labeling engine 110 (i) performs segmentation and feature extraction in the video space, leveraging video object segmentation (VOS) and vision-language foundation models to generate video space object labels, (ii) lifts (i.e., projects) the video space object labels to the 4D point cloud space, and (iii) flattens the resulting 4D point cloud space labels to resolve ambiguities in assignment of labels to points. In at least one embodiment, pseudo-labeling engine 110 performs segmentation and feature extraction via segmentation model(s) 232 and vision encoder 234 of FIG. 2B, performs lifting of the video space object labels to the 4D point cloud space via projector 236 of FIG. 2B, and performs flattening of the 4D point cloud space labels via flattening engine 238 of FIG. 2B. During a second, cross-window association stage, pseudo-labeling engine 110 operates across multiple (i.e., two or more) windows to establish correspondences between object labels generated—in different windows—for the same specific object or region of interest. In at least one embodiment, pseudo-labeling engine 110 establishes correspondences between object labels of different time windows via stitching engine 252 of FIG. 2D. The output of the pseudo-labeling engine 110 is a proxy dataset 104, which includes 4D point clouds and corresponding temporally consistent object labels.

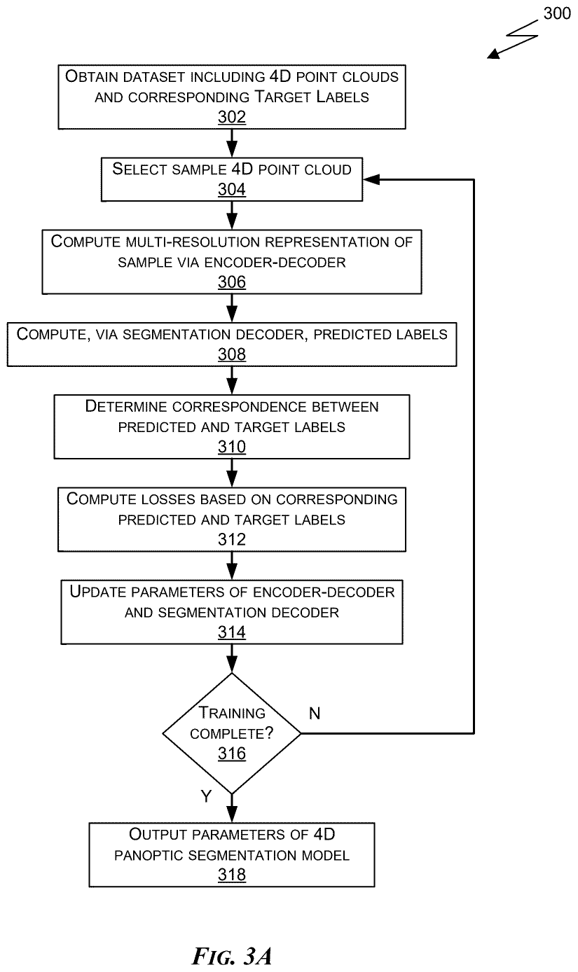

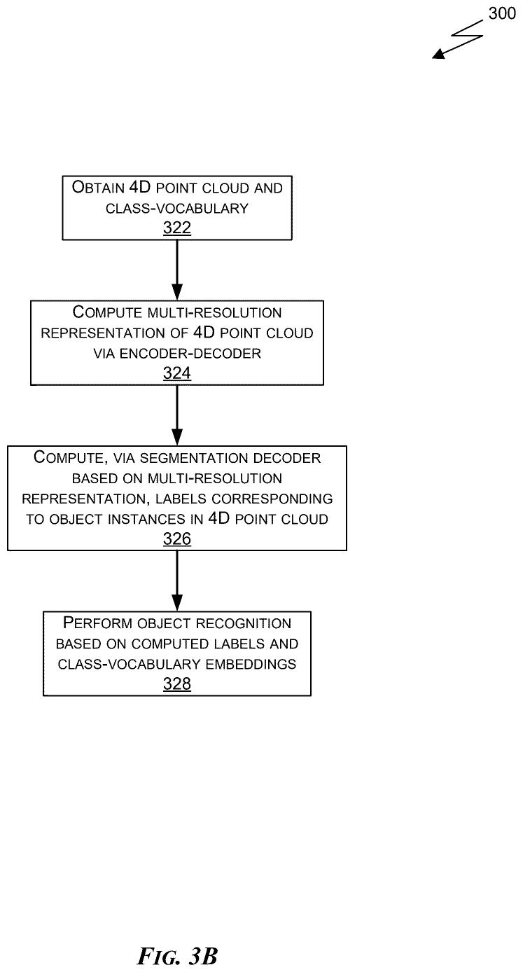

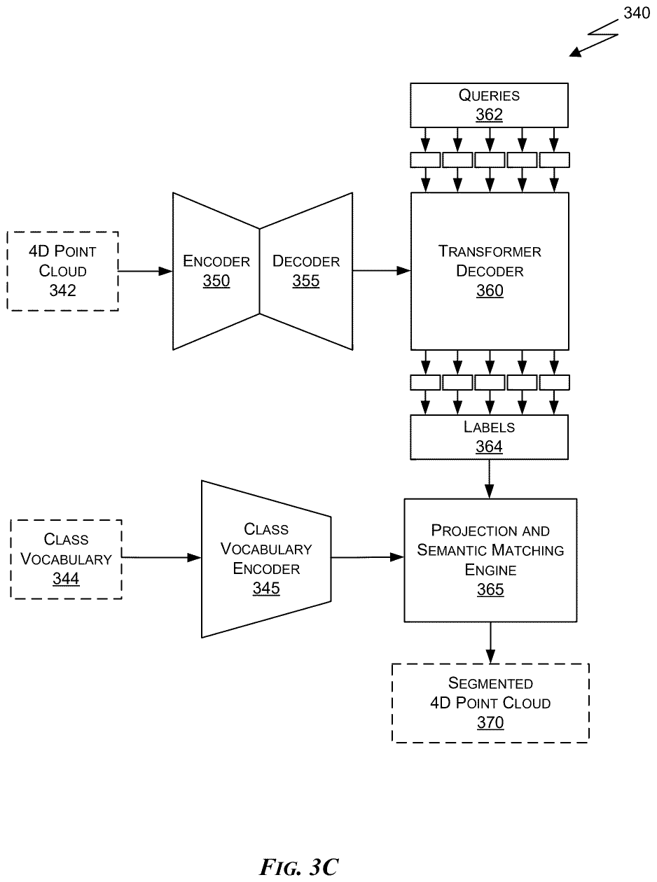

Optimization engine 120 utilizes proxy dataset 104 to train a 4D panoptic segmentation model via end-to-end learning. Optimization engine 120 receives, as input, both the proxy dataset 104 and an untrained 4D panoptic segmentation model 106, and provides, as output, the set of model parameters 108 of a trained zero-shot 4D panoptic segmentation model. The trained zero-shot 4D panoptic segmentation model is capable of segmenting, tracking, and recognizing arbitrary objects in dynamic 4D scenes. In at least one embodiment, optimization engine 120 trains the untrained 4D panoptic segmentation model 106 to generate the set of model parameters 108 by performing method 300 of FIG. 3A. In at least one embodiment, the untrained 4D panoptic segmentation model 106 has the architecture of the system 340 for performing panoptic segmentation of 4D point clouds of FIG. 3C.

FIG. 2A is a flow diagram illustrating a method 200 for labeling objects in 4D point clouds, in accordance with one or more embodiments. Each block of method 200, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API), or a plug-in to another product, to name a few. In addition, method 200 is described, by way of example, with respect to the systems of FIGS. 1, 2B, and 2D. However, this method may additionally or alternatively be executed by any one system, or any combination of systems, including, but not limited to, those described herein. Furthermore, persons of ordinary skill in the art will understand that any system that performs method 200 is within the scope and spirit of embodiments of the present disclosure.

FIG. 2A illustrates a method 200 for generating temporally consistent, semantically labeled 4D point clouds from paired point cloud and video data. The method 200 leverages video object segmentation (VOS) and vision-language foundation models to label objects in 4D point clouds, e.g., 4D LiDAR point clouds. In at least one embodiment, method 200 is performed, at least in part, by a combination of the system 220 of FIG. 2B and the system 250 of FIG. 2D. In at least one embodiment, the system 220 of FIG. 2B performs steps 206 through 212 and the system 250 of FIG. 2D performs step 216.

At step 202, method 200 obtains a 4D point cloud (i.e., a temporal sequence of 3D point clouds) paired with a corresponding set of one or more videos (i.e., a set one or more videos, each being captured by a different camera, corresponding to the temporal sequence of 3D point clouds) time-synchronized with the 4D point cloud. In at least one embodiment, the 4D point cloud is a LiDAR point cloud. In at least one embodiment, the set of one or more videos is a set of canonical videos that provide consistent coverage and viewpoint stability across scenes. In at least one embodiment, the set of one or more videos are captured by calibrated cameras with a fixed positional relationship relative to a 3D sensor system that captures the 4D point cloud. In at least one embodiment, the 4D point cloud is

$$𝒫 = {\{ {P}_{t} \}}_{t = 1}^{T} ,$$

and the set of one or more videos includes C videos

$$𝒱 = {\{ {𝒱}^{c} \}}_{c = 1}^{C} ,$$

where each video

$${𝒱}^{c} = {\{ {I}_{t}^{c} \}}_{t = 1}^{T}$$

consists of images

$${I}_{t}^{c}$$

ε [symbol] of spatial dimensions H×W, captured by camera c at time t.

At step 204, a k^{th} time window is specified. The time window defines a temporal slice (i.e., of a full-length time period corresponding to the 4D point cloud obtained at 202) for a single iteration of downstream processing. In at least one embodiment, the k^{th} time window is one of k time windows wₖ={(Pₜ, Iₜ)|t∈Tₖ}, each of which include 3D point clouds and image frames over specific time frames Tₖ={tₖ, tₖ₊₁, . . . , tₖ+K−1} (camera index c is omitted for simplicity).

At step 206, one or more segmentation models are utilized to segment and track object instances in video clips, i.e., slices of the one or more canonical videos obtained at 202 that correspond to the k^{th} time window. In at least one embodiment, the one or more segmentation models include one or more of an image segmentation foundation model and a video object segmentation foundation model. In at least one embodiment, the image segmentation foundation model is the Segment Anything Model (SAM) (as detailed in Kirillov, et al., Segment anything, in Int. Conf. Comput. Vis., 2023, which is incorporated by reference herein), and the video segmentation model is the SAMv2 model (as detailed in Ravi, et al., Sam 2: Segment anything in images and videos, arXiv preprint arXiv: 2408.00714, 2024, which is incorporated by reference herein). The one or more segmentation models generate, for each video clip, a set of masks (each of which identifies an object instance or region of interest) and, for each mask, an identifier. The masks are temporally consistent within the time window k. In at least one embodiment, at step 206, an image segmentation model segments the first frame of each video clip for the time window k, localizing objects present therein as masks {m_{i,t}_{ₖ}}, where each mask m_{i,t}_{ₖ}∈{0,1}^{H×W} is defined in an image space of dimensions H×W, and a video segmentation model propagates the masks determined by the image segmentation model through the entire time window k, thereby providing masks {m_{i,t}|t∈Tₖ} for each object instance i, resulting in overlapping masks in a 3D video volume of dimensions H×W×K, representing objects visible in Iₜ_{ₖ} across the time window wₖ. In at least one embodiment, only objects observable in the first frame Iₜ_{ₖ} of the time window wₖ are labeled, while objects appearing after tₖ within wₖ are not labeled in that window.

At step 208, a vision encoder is utilized to extract features for each mask generated at 204. In at least one embodiment, the vision encoder is a vision encoder foundation model. In at least one embodiment, the vision encoder is the CLIP model (as detailed in Radford et al., Learning transferable visual models from natural language supervision, in Int. Conf. Mach. Learn., 2021, which is incorporated by reference herein). The extracted features are semantic embeddings that capture high-level characteristics of the objects or regions of interest represented by the masks. In at least one embodiment, the semantic embeddings for each mask m_{i,t} are f_{i,t}. In at least one embodiment, the semantic embeddings are vocabulary-agnostic semantic feature vectors produced by a vision-language encoder that embeds objects or regions into a shared image-text embedding space (e.g., CLIP tokens).

Following steps 206 and 208, each video clip is labeled with video space object labels for the k^{th} time window. In at least one embodiment, each video space object label is a tuple including (i) a mask (e.g., a binary segmentation mask) that selects specific pixels in a sequence of frames of a video clip that belong to a specific object or region of interest, (ii) an object identifier (e.g., a natural number) that uniquely identifies the specific object or region of interest, and (iii) a semantic feature (e.g., an embedding vector) that assigns class labels and/or other meaningful information to the pixels that belong to the specific object or region of interest. In at least one embodiment, the semantic feature is an average, across all frames of the time window k, of per-frame embedding vectors corresponding to the specific object or region of interest. As compared to a model that generates a semantic feature based on only a single frame, generating a semantic feature by averaging multiple embedding vectors across the time window k reduces noise, improves robustness, and boosts semantic prediction performance. In at least one embodiment, each video space object label is {(m_{i,t}, id_{i,k}, f_{i,t})|t∈Tₖ} for each object instance i, where id_{i,k} is a local instance identifier within time window wₖ.

At step 210, the masks generated at 206 are lifted from the video space to the 4D point cloud space. The lifting is performed independently for each video clip, resulting in a set of overlapping 4D point cloud space masks for each object instance. In at least one embodiment, lifting the masks from the video space to the 4D point cloud space comprises projecting each mask into a coordinate frame of the 4D point cloud based on calibration data associated with the one or more LiDAR sensors via which data corresponding to the 4D point cloud was acquired and calibration data associated with one or more cameras via which the video clips were acquired. In at least one embodiment, step 210 yields, for each camera c, in sets of object labels

$$\{ ( {\tilde{m}}_{i , t}^{c} , {id}_{i , k}^{c} , {f}_{i , t}^{c} ) \}$$

in 4D point cloud space. In at least one embodiment, object instances corresponding to different cameras are merged where the intersection-over-union exceeds a threshold, and their features f_{i,t} are averaged as weighted by mask area. In at least one embodiment, the merging object instances corresponding to different cameras yields tuples {(\tilde{m}_{i,t}, id_{i,k}, f_{i,t})|t∈Tₖ}, representing spatiotemporal instances localized in time window wₖ. In at least one embodiment, density-based clustering is performed to refine the 4D point cloud space masks and thereby address calibration errors and sensor misalignment. In at least one embodiment, an ensemble of DBSCAN clusters are created by varying a parameter density parameter and replacing all lifted masks with DBSCAN masks that have sufficient overlap.

At step 212, spatiotemporal flattening is implemented to flatten sets of overlapping 4D point cloud space masks into a single mask that identifies an object instance or region of interest in the 4D point cloud obtained at 202. As a result of the spatiotemporal flattening, each point in k^{th} temporal slice of the 4D point cloud is assigned to a single object instance or region of interest without duplication. The spatiotemporal flattening thereby resolves any ambiguities resulting from assigning labels to individual points in the 4D point cloud space in accordance with the overlapping masks. In at least one embodiment, spatiotemporal flattening at step 212 includes one or more of: (i) computing a spatiotemporal volume Vᵢ of each mask \tilde{M}ᵢ={\tilde{m}_{i,t}|t∈Tₖ} by summing the number of points across all frames, Vᵢ=Σ_{t∈T}_{ₖ}|\tilde{m}_{i,t}|, where |\tilde{m}_{i,t}| denotes the number of points in mask \tilde{m}_{i,t}; (ii) sorting the masks in descending order based on their volumes Vᵢ; and/or (iii) incrementally suppressing masks with intersection-over-minima larger than a predefined threshold.

Following step 212, the 4D point cloud is labeled with 4D point cloud space object labels for the k^{th} time window. In at least one embodiment, each object label is a tuple including (i) a mask (e.g., a binary segmentation mask) that selects specific points, in a sequence of 3D point clouds, that belong to a specific object or region of interest (i.e., the mask provides a 4D “tube” or a sequence of 3D binary masks), (ii) an object identifier (e.g., a natural number) that uniquely identifies the specific object or region of interest, and (iii) a semantic feature (e.g., an embedding vector) that assigns class labels and/or other meaningful information to the points that belong to the specific object or region of interest.

At step 214, method 200 determines whether the current time window k is a final time window. If the current time window is not the final time window, method 200 increments k and returns to 202 to set the next temporal window. Alternatively, if the current time window k is the final time window, method 200 proceeds to step 216.

At step 216, 4D point cloud space object labels for different time windows are correlated for the full-length time period of the 4D point cloud (or for an arbitrary temporal subset thereof). In at least one embodiment, correlating object labels across different time windows is performed by solving a linear assignment problem; identities corresponding to the same specific object instance or region of interest in different time windows are merged, and semantic features corresponding to the same specific object instance or region of interest are aggregated over all time windows. In at least one embodiment, 4D point cloud space object labels for different time windows are correlated to provide tuples

$${\{ {\tilde{m}}_{i , t} , {id}_{i} , {f}_{i} \}}_{i = 1}^{{N}_{t}} ,$$

where \tilde{m}_{i,t}∈{0,1}^{N}^{ₜ} represents the binary segmentation mask for instance i at time t in the point cloud Pₜ idᵢ∈ [symbol] is the unique object identifier for spatiotemporal instance i, consistent across the k^{th} time window, and fᵢ∈ [symbol] is the corresponding semantic feature, representing instance semantics aggregated over time. In at least one embodiment, 4D point cloud space object labels for different time windows are correlated by one or more of: (i) solving a linear assignment problem for each pair of overlapping windows (wₖ₋₁, wₖ), where a cost cᵢⱼ is defined as dissimilarity between instances in the overlapping frames Tₖ₋₁∪Tₖ, i.e., cᵢⱼ=1−IoU_{3D}(\tilde{m}_{i,k-1},\tilde{m}_{j,k}), where \tilde{m}_{i,k-1} and \tilde{m}_{j,k} are the aggregated masks of instances i and j over the overlapping frames; (ii) updating, after association, global instance identifiers idᵢ for matched instances; (iii) aggregating semantic features fᵢ of matched instances over all time windows; and/or (iv) removing, as a final post-processing step, instances that are shorter than a specified temporal threshold τ (i.e., instances appearing in fewer than τ frames).

At step 218, a labeled 4D point cloud is provided as output. In at least one embodiment, each object label is a tuple including (i) a binary object segmentation mask, (ii) an object identifier, and (iii) a semantic feature vector. Method 200 is repeated for numerous different scenes, producing a dataset (e.g., proxy dataset 104) that includes numerous labeled 4D point clouds suitable for training a 4D panoptic segmentation model.

FIG. 2B is a block diagram illustrating a system 220 for generating labeled 4D point cloud clips, in accordance with one or more embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories.

FIG. 2B shows a system 220 for generating labeled 4D point cloud clips from multi-modal sensory data. The system 220 is configured to receive, as input, a 4D point cloud clip 222 and a corresponding set of video clips 224A, 224B, . . . , 224N. The system 220 includes, a segmentation model 232, a vision encoder 234, a projector 236, and a flattening engine 238. The output of the system 220 is a labeled 4D point cloud clip 242 annotated with temporally consistent object labels and semantic features. Each of these elements is described in detail below.

The 4D point cloud clip 222 is a temporal sequence of 3D point clouds, and each of video clips 224A, 224B, and 224C is a temporal sequence of 2D frames captured by a camera. Each video clip thereby provides visual information from a different viewpoint, enabling the system 220 to leverage complementary visual perspectives for improved segmentation and semantic feature extraction. The temporal sequence of 3D point clouds and the temporal sequences of 2D frames are aligned such that each point cloud corresponds to specific frames in each of the video clips.

Segmentation model 232 receives the set of video clips 224A, 224B, . . . , 224N as input and performs video object segmentation. The segmentation model 232 processes each frame of each video clip to identify and delineate objects or regions of interest, generating binary segmentation masks for each detected object or region. The output of segmentation model 232 is a set of segmented video clips, each containing one or more binary masks corresponding to distinct objects or regions of interest. In at least one embodiment, segmentation model 232 is implemented using a an image segmentation foundation model, such as SAM, and/or a video object segmentation foundation model, such as SAMv2. In at least one embodiment, segmentation model 232 incorporates a transformer-based video object segmentation backbone that extends an image transformer with temporal attention (e.g., multi-head self- and/or cross-attention over frame-wise feature maps) and memory tokens to propagate instance masks across consecutive frames. In at least one embodiment, segmentation model 232 is a convolutional neural network (CNN)-transformer hybrid network that includes a convolutional encoder to extract per-frame features followed by a temporal transformer decoder that processes learnable queries to produce per-object mask logits and track embeddings over the duration of each clip. In at least one embodiment, segmentation model 232 includes a fully convolutional recurrent network that couples a 2D CNN with Convolutional Long Short-Term Memory (ConvLSTM)/Convolutional Gated Recurrent Unit (ConvGRU) layers to maintain temporal state and uses a per-instance dynamic mask head to refine object boundaries and suppress overlaps. In at least one embodiment, segmentation model 232 includes an image encoder, e.g., a vision transformer (ViT), a prompt encoder, and a mask decoder augmented with video modules (e.g., optical flow or attention-based propagation) to initialize masks in a first frame and propagate them through the clip.

The vision encoder 234 receives the segmented videos from the segmentation model 232 and extracts semantic features for each segmented object or region. The vision encoder 234 processes the binary masks and the corresponding video frames to generate high-dimensional embedding vectors that encode visual and semantic information (i.e., semantic feature embeddings) for each segmented object or region. In at least one embodiment, the vision encoder 234 is implemented using a vision-language foundation model, such as CLIP, which produces embedding vectors that are aligned with natural language descriptions. In at least one embodiment, vision encoder 234 incorporates a dual-encoder vision-language network that includes a visual encoder (e.g., a ViT with multi-head self-attention and patch embedding, or a CNN backbone with global pooling) and a text encoder (e.g., a transformer). In at least one embodiment, the vision encoder 234 is the MaskCLIP model (as detailed in Ding, et al., Open-Vocabulary Universal Image Segmentation with MaskCLIP, in Int. Conf. Mach. Learn., 2023, which is incorporated by reference herein).

The projector 236 receives the segmented videos with associated semantic embeddings from the vision encoder 234 and lifts the segmentation information from the video space to the 4D point cloud space. The projector 236 maps each pixel in a segmentation mask to the corresponding points in the 4D point cloud clip 222, thereby associating each point in the point cloud with a binary mask identifier and a semantic embedding vector. In at least one embodiment, the projector 236 utilizes calibration data to accurately project segmentation masks from each video domain to the point cloud domain. The output of the projector 236 is a set of point clouds with overlaid semantic features. In at least one embodiment, the projector 236 is implemented via a calibration and projection module, implemented on one or more GPUs, that performs per-pixel ray casting and camera-to-point cloud coordinate transforms.

The flattening engine 238 receives the point clouds with overlaid semantic features from the projector 236 and resolves ambiguities arising from overlapping segmentation masks. The flattening engine 238 consolidates overlapping annotations into a coherent, non-overlapping mask for each object or region, ensuring that each point in the 4D point cloud is assigned to a single segmented object or region. In one or more embodiments, the flattening engine 238 implements a spatiotemporal flattening process that favors larger and temporally consistent instances, suppressing smaller or conflicting masks based on predefined criteria. The output of the flattening engine 238 is a flattened point cloud with distinct object assignments. In at least one embodiment, flattening engine 238 is implemented via a flattening module, implemented on one or more GPUs, that performs overlap tests (e.g., intersection-over-minima) to suppress conflicting masks and write unique point-to-instance assignments.

The segmented 4D point cloud clip 242 is an output element representing the final result of the system 220. The segmented 4D point cloud clip 242 contains temporally consistent object labels, including binary segmentation masks, distinct object identifiers, and semantic feature embeddings for each object or region.

FIG. 2C is a block diagram illustrating processing of a 4D point cloud clip paired with a corresponding set of video clips to generate a labeled 4D point cloud clip, in accordance with one or more embodiments. The set of video clips 224A, 224B, and 224C are provided as input to the segmentation model 232, which performs video object segmentation and outputs segmented video clips, each containing one or more binary masks corresponding to distinct objects or regions of interest, to the vision encoder 234. The vision encoder 234 extracts semantic features for each segmented object or region in the segmented video clips output by segmentation model 232, thereby producing a set of labeled video clips 226A, 226B, and 226C. The labeled video clips are projected into the point cloud space to produce a set of labeled 4D point cloud clips 228A, 228B, and 228C, which are subsequently flattened to generate the labeled 4D point cloud clip 242.

FIG. 2D is a block diagram illustrating a system 250 for generating full-length labeled 4D point cloud by stitching a plurality of labeled 4D point cloud clips, in accordance with one or more embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories.

FIG. 2D shows a system 250 for generating a full-length labeled 4D point cloud by stitching together a plurality of labeled 4D point cloud clips 242. The system 250 utilizes stitching engine 252 to generate and output a labeled 4D point cloud 255 that provides temporally consistent object labels and semantic features across a full-length scene. System 250 thereby provides a unified, temporally coherent representation suitable for advanced spatiotemporal scene understanding by aggregating a plurality of temporally overlapping annotated 4D point cloud clips. Challenges such as object occlusion, rapid motion, and objects entering or exiting the sensing area are addressed by leveraging temporal overlap and consistency of the labeled 4D point cloud clips 242, and the stitching engine 252 ensures that object identities are maintained across the full-length scene and aggregates semantic features to provide robust recognition capabilities.

Stitching engine 252 receives, as input, a plurality of labeled 4D point cloud clips 242, each representing a temporally segmented portion of a full-length 4D point cloud. In each labeled 4D point cloud clip, points are annotated with object/region indicators, instance identifiers, and semantic feature embeddings. In at least one embodiment, each labeled 4D point cloud clip 242 is generated by system 220 of FIG. 2B. In at least one embodiment, the labeled 4D point cloud clips 242 collectively cover the full temporal extent of the scene, with overlap between adjacent clips to facilitate cross-window association. In at least one embodiment, the stitching engine 252 performs operations to correlate, merge, and associate object instances across the temporal boundaries of the labeled 4D point cloud clips 242. In one or more embodiments, the stitching engine 252 implements a linear assignment algorithm to solve the correspondence problem between object instances in overlapping time windows. The stitching engine 252 merges object identities that correspond to the same physical object or region of interest across different clips, and aggregates semantic feature embeddings for each object instance over all time windows. The stitching engine 252 thereby produces a temporally coherent set of object labels and semantic features that span the entire 4D point cloud sequence, which are output as the labeled 4D point cloud 255. In at least one embodiment, the stitching engine 252 is implemented via a GPU-accelerated association pipeline that computes inter-window cost matrices, executes batched linear assignment operations, and updates global instance IDs and aggregated feature embeddings. In at least one embodiment, the labeled 4D point cloud 255 includes, for each object or region of interest, a binary segmentation mask, an object identifier, and a semantic feature embedding.

FIG. 3A is a flow diagram illustrating a method 300 for training a 4D panoptic segmentation model, in accordance with one or more embodiments. Each block of method 300, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API), or a plug-in to another product, to name a few. In addition, method 300 is described, by way of example, with respect to the systems of FIGS. 1 and 3C. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

FIG. 3A illustrates a method 300 for training a 4D panoptic segmentation model, using a proxy dataset (e.g., generated via multiple iterations of method 200), to segment, track, and recognize objects in 4D point clouds. Method 300 iteratively optimizes model parameters of a 4D panoptic segmentation model through a series of computational steps, using a training dataset including labeled 4D point clouds.

At step 302, method 300 obtains a proxy dataset that includes 4D point clouds and corresponding target labels that provide supervisory signals for training the 4D panoptic segmentation model. In at least one embodiment, the target labels are generated by leveraging video object segmentation and vision-language foundation models, e.g., using the pseudo-labeling engine 110 or by performing method 200.

At step 304, a sample 4D point cloud is selected from the training dataset 104. This sample represents a temporal sequence of 3D point clouds, which are used as input for the training process.

At step 306, the selected sample 4D point cloud is processed through an encoder-decoder backbone to compute a multi-resolution representation of the 4D point cloud, e.g., in the form of a 4D spatiotemporal voxel-based representation. In at least one embodiment, the encoder-decoder backbone is a Minkowski U-Net configured to utilize sparse 3D convolutions to extract spatiotemporal features from the selected sample 4D point cloud.

At step 308, a segmentation decoder processes the multi-resolution representation to compute predicted labels—which include spatiotemporal masks—for the selected sample 4D point cloud. In at least one embodiment, the segmentation decoder is a transformer decoder that processes both learnable queries and the output of the encoder-decoder backbone to generate the predicted masks. In at least one embodiment, the transformer decoder outputs, for each learnable query, a spatiotemporal mask, an objectness score (i.e., a likelihood that the query represents an object), and a feature embedding. A number of the learnable queries (which limits the maximum number of identifiable objects) is a hyperparameter that can be specified prior to training (and which is typically set in the hundreds).

At step 310, method 300 determines correspondences between the predicted labels, generated at 308, and the target labels corresponding to the sample 4D point cloud from proxy dataset 104. At step 312, losses are computed for pairs of corresponding predicted and target labels. In at least one embodiment, the losses are composite losses that include an objectness loss component, a segmentation loss component, and a token loss component, which collectively measure the performance of the model in localizing, segmenting, and recognizing object and/or regions of interest. In at least one embodiment, a number of the predicted labels exceeds a number of the target labels such that a number of unmatched predicted labels remain following step 310. In at least one embodiment, an objectness loss component is determined for each unmatched predicted label, while segmentation loss components and token loss components for unmatched predicted labels are assigned a value of zero. In at least one embodiment, the losses computed at step 312 are given by [symbol] _{SAL-4D}= [symbol] _{obj}+ [symbol] _{seg}+ [symbol] ₜₒₖₑₙ, where cross-entropy loss [symbol] _{obj} indicates whether a mask localizes an object, segmentation loss [symbol] _{seg} is a binary cross-entropy loss and a dice loss, and token loss [symbol] ₜₒₖₑₙ is a cosine distance between a predicted feature embedding and a target feature embedding. By evaluating each component of the composite loss over a sequence of 3D point clouds corresponding to a time interval K (rather than, e.g., at the level of an individual frame corresponding to a single point in time), the 4D panoptic segmentation model learns to segment and associate object instances over time, thereby encouraging semantic coherence across the sequence of 3D point clouds.

At step 314, parameters of the encoder-decoder backbone and of the segmentation decoder are updated based on the computed losses. At step 316, method 300 determines whether the training process is complete (e.g., by determining whether additional samples remain in the proxy dataset or by considering alternative termination criteria). If training is not complete, method 300 loops back to step 304 to select another sample from the proxy dataset 104. Alternatively, if training is complete, method 300 proceeds to step 318, where the parameters of a trained 4D panoptic segmentation model (e.g., parameters 108 of FIG. 1) are output.

FIG. 3B is a flow diagram illustrating a method 320 for performing 4D panoptic segmentation, in accordance with one or more embodiments. Each block of method 320, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API), or a plug-in to another product, to name a few. In addition, method 320 is described, by way of example, with respect to the system of FIG. 3C. However, this method may additionally or alternatively be executed by any one system, or any combination of systems, including, but not limited to, those described herein. Furthermore, persons of ordinary skill in the art will understand that any system that performs method 320 is within the scope and spirit of embodiments of the present disclosure.

At step 322, method 320 obtains a 4D point cloud and a class-vocabulary as input. In at least one embodiment, the 4D point cloud is a temporal sequence of 3D LiDAR point clouds, captured by one or more LiDAR sensors over a period of time. In at least one embodiment, the 4D point cloud is captured by LiDAR sensor(s) 664 of vehicle 600. The class-vocabulary is a set of predefined semantic classes or object descriptions that are used for recognition during the segmentation process. In at least one embodiment, the class-vocabulary includes canonical object classes, such as vehicles, pedestrians, and cyclists, as well as arbitrary object classes specified by a user.

At step 324, method 320 computes a multi-resolution representation of the 4D point cloud using an encoder-decoder backbone. The encoder-decoder backbone processes the 4D point cloud to extract spatiotemporal features and generate a hierarchical representation of the data. In one or more embodiments, the encoder-decoder backbone utilizes sparse 3D convolutions, such as those implemented in a Minkowski U-Net, to efficiently capture spatial and temporal information from the 4D point cloud. The multi-resolution representation provides a detailed and structured understanding of the scene, enabling downstream segmentation and recognition tasks.

At step 326, method 320 employs a segmentation decoder to compute labels corresponding to object instances in the 4D point cloud based on the multi-resolution representation. The segmentation decoder processes the hierarchical features generated by the encoder-decoder backbone to predict spatiotemporal masks for individual object instances. Each mask identifies specific points in the 4D point cloud that belong to a particular object or region of interest. In one or more embodiments, the segmentation decoder also outputs additional information, e.g., objectness scores and feature embeddings, to facilitate object recognition and classification. In at least one embodiment, the segmentation decoder is implemented as a transformer decoder that utilizes learnable queries to generate predictions for multiple object instances simultaneously.

At step 328, method 320 performs object recognition based on the computed labels and class-vocabulary embeddings. The recognition process involves comparing the feature embeddings associated with the predicted labels to the embeddings of the class-vocabulary. In at least one embodiment, the class-vocabulary embeddings are generated using a vision-language foundation model, such as CLIP, which encodes semantic descriptions of object classes into a high-dimensional feature space. By computing similarity scores between the predicted feature embeddings and the class-vocabulary embeddings, method 320 assigns semantic labels to the segmented object instances, thereby supporting open-vocabulary recognition and segmentation of arbitrary objects.

FIG. 3C is a block diagram illustrating a system 340 for 4D panoptic point cloud segmentation, in accordance with one or more embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories.

FIG. 3C shows a system 340 for performing panoptic segmentation of 4D point clouds. The system 340 is configured to process a temporal sequence of 3D point clouds (i.e., a 4D point cloud) that represent a scene and output temporally consistent labels (e.g., tuples of segmentation masks, object identifiers, and semantic features) for each object instance in the scene. System 340 includes a class vocabulary encoder 345, a point cloud encoder 350/decoder 355, a transformer decoder 360 with learnable queries 362, and a projector 365.

The 4D point cloud input 342 is an input element that represents a temporal sequence of 3D point clouds. In various embodiments, the 4D point cloud input 342 is captured by a LiDAR sensor mounted on a moving platform, such as an autonomous vehicle or robot. In at least one embodiment, the 4D point cloud input 342 is captured by LiDAR sensor(s) 664 of vehicle 600.

The class vocabulary input 344 is an input element that provides a set of semantic class descriptions or object categories to be recognized in the segmentation process. The class vocabulary input 344 may include canonical object classes (e.g., “car,” “pedestrian,” “bicycle”) as well as arbitrary or user-specified object descriptions. The class vocabulary input 344 enables the system 340 to support open-vocabulary recognition and segmentation of objects in the 4D point cloud.

The class vocabulary encoder 345 receives the class vocabulary 344 as input and encodes each class description in the class vocabulary into a high-dimensional semantic embedding. In one or more embodiments, the multimodal encoder 345 is implemented using a vision-language foundation model, such as CLIP, which projects textual descriptions into a feature space that is compatible with feature embeddings produced by a segmentation model. The output of the multimodal encoder 345 is a set of class embeddings used for semantic matching during object recognition.

Point cloud encoder 350/decoder 355 collectively generate a multi-resolution spatiotemporal representation of the 4D point cloud 342, enabling downstream segmentation and labeling tasks. In at least one embodiment, the encoder 350/decoder 355 is implemented as a Minkowski U-Net or a similar architecture designed for efficient processing of high-dimensional point cloud data. The encoder 350 processes the input sequence using sparse 3D convolutions or similar operations to extract features that capture both spatial structure and temporal dynamics, while the decoder 355 receives the extracted features from the encoder 350 and refines them to produce a dense feature representation suitable for segmentation. The encoder 350 employs downsampling operations, the decoder 355 employs upsampling operations, and skip connections preserve fine-grained spatial details while integrating temporal context. The output of the encoder 350/decoder 355 is a feature tensor that encodes information at multiple spatial and temporal scales.

Transformer decoder 360 receives the feature tensor from the decoder 355 and also receives a set of learnable queries 362. The transformer decoder 360 processes the learnable queries, based on the feature tensor, to predict spatiotemporal masks and corresponding labels, e.g., objectness scores and feature embeddings, for individual object instances. In one or more embodiments, the transformer decoder 360 is implemented as a multi-head attention module that enables each query to attend to relevant regions in the feature tensor, thereby generating instance-specific predictions. The learnable queries 362 are trainable parameters that represent potential object instances or regions of interest in the 4D point cloud 342.

The projection and semantic matching engine 365 receives binary segmentation masks and corresponding feature embeddings output by transformer decoder 360, as well as class embeddings output by the class vocabulary encoder 345. The projection and semantic matching engine 365 maps the binary segmentation masks output by the transformer decoder 360 onto the original 4D point cloud 342. In at least one embodiment, the projection and semantic matching engine 365 resolves overlapping predictions by enforcing a one-to-one assignment of points to instance masks and consolidates ambiguous labels into coherent, non-overlapping segments. The projection and semantic matching engine 365 also performs semantic matching by comparing the feature embeddings output by the transformer decoder 360 with the class embeddings provided by the class vocabulary encoder 345, and, based on the comparing, assigns a semantic label corresponding to a class in the class vocabulary 344 to each binary segmentation mask (i.e., to each segmented object instance) in the 4D point cloud 342. In at least one embodiment, projection and semantic matching engine 365 is implemented via a GPU-based pipeline that processes the binary segmentation masks and point-clouds, resolves inter-mask overlaps in space-time, and performs batched cosine similarity scoring between per-object instance feature embeddings and class-vocabulary embeddings.

The segmented 4D point cloud output 370 is an output element that represents the final result of the system 340. The segmented 4D point cloud 370 includes temporally consistent binary segmentation masks and corresponding object instance labels, e.g., distinct object identifiers and semantic feature embeddings, for each identified object or region. In one or more embodiments, the labeled 4D point cloud output 370 is provided to a motion planning and control stack of an autonomous vehicle or humanoid robot.

In at least one embodiment, the temporally coherent binary segmentation masks and corresponding semantic labels of the segmented 4D point cloud 370 are fused into an occupancy and semantics map that delineates drivable or traversable space, dynamic actors (e.g., vehicles, pedestrians), and static infrastructure (e.g., curbs, signage). A tracking module consumes the per-instance identities to predict short-horizon trajectories of dynamic objects, while a behavior planner uses these predictions, together with lane geometry and right-of-way rules, to select maneuvers such as lane changes, crossing, or yielding. The system continuously updates the 4D scene model as new labeled point clouds arrive, allowing real-time replanning and actuation (steering, throttle, braking for vehicles; footstep placement, limb motion for humanoids) under changing conditions and occlusions.

In at least one embodiment, the temporally coherent binary segmentation masks and corresponding semantic labels of the segmented 4D point cloud 370 are fused into an occupancy and semantics map tailored to humanoid locomotion and manipulation, delineating traversable floor regions, stairs, ramps, obstacles, and task-relevant objects (e.g., doors, handles, tools). A tracking module maintains per-instance identities for nearby humans and moving objects to forecast short-horizon trajectories, while a whole-body motion planner leverages these predictions, together with kinematic reachability and contact stability constraints, to select footholds, plan step sequences, and schedule grasp or push interactions. The system continuously updates the 4D scene model as new labeled point clouds arrive, enabling real-time adaptation of gait, balance, and arm motions to avoid collisions, yield right-of-way in crowded spaces, open doors, pick up or place items, and traverse cluttered environments under occlusions and changing conditions.

Techniques of the present disclosure overcome limitations of existing methodologies by addressing limitations of single-scan segmentation and enabling temporally coherent spatiotemporal understanding of 4D scenes. Unlike conventional approaches for point cloud segmentation, techniques of one or more embodiments of the present disclosure do not rely on predefined class vocabularies or manual annotations for training a 4D panoptic segmentation model, thereby supporting open-vocabulary recognition and segmentation of arbitrary objects. Furthermore, according to one or more embodiments, the techniques of the present disclosure provide a specialized pipeline that ensures temporal consistency in point-to-instance assignments, first predicting binary point masks in short time windows and subsequently linking masks that correspond to the same specific instance of an object or region of interest in different time windows by consideration of overlap frames. According to one or more embodiment, the techniques of the present disclosure thereby provide enhanced zero-shot recognition capabilities, e.g., in LiDAR-based systems. For example, in the context of autonomous vehicles, 4D panoptic segmentation performed pursuant to one or more embodiments yields temporally consistent instance identities and semantics that improve delineation of drivable space, robustly track and predict trajectories of dynamic actors under occlusions, and recognize previously unseen hazards or infrastructure in an open-vocabulary manner, thereby enhancing situational awareness and enabling safer, more reliable planning and control. Similarly, in the context of humanoid robots, 4D panoptic segmentation performed pursuant to one or more embodiments yields stable, time-aware occupancy and semantics maps that support footstep planning and whole-body motion under changing conditions, enabling zero-shot recognition of novel task-relevant objects (e.g., doors, handles, tools) for manipulation, crowd-aware navigation, and collision avoidance.

Systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

In some examples, the model(s) (e.g., machine learning models, deep neural networks, language models, LLMs, VLMs, multi-modal language models, perception models, tracking models, fusion models, transformer models, diffusion models, encoder-only models, decoder-only models, encoder-decoder models, neural radiance field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs, e.g., REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

More illustrative information will now be set forth regarding various optional architectures and features with which one or more embodiments may be implemented, per the desires of the user. It should be strongly noted that the following information is set forth for illustrative purposes and should not be construed as limiting in any manner. Any of the following architectures and features may be optionally incorporated with or without the other architectures and features described.

### Parallel Processing Architecture

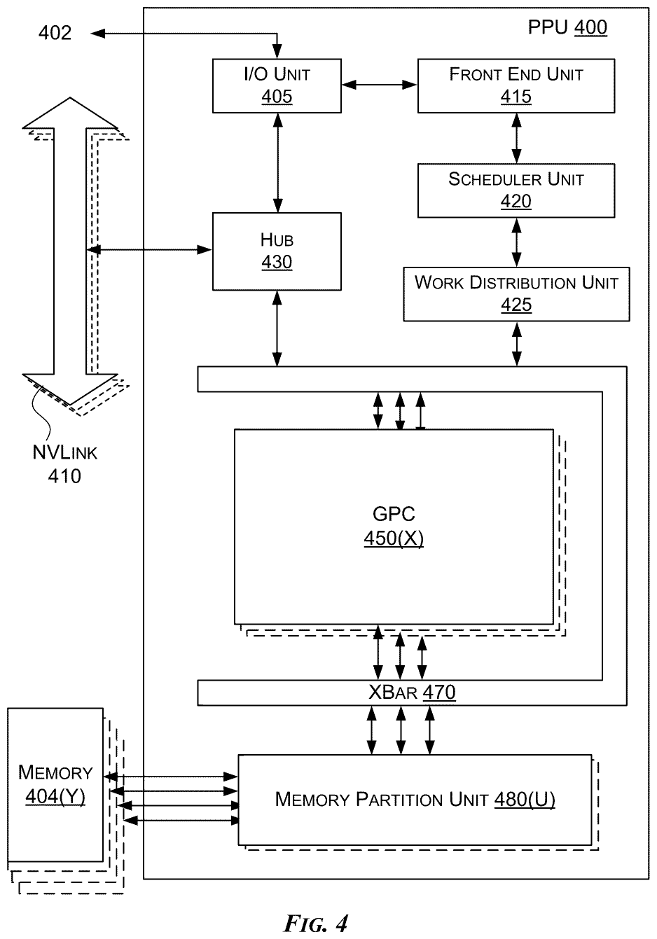

FIG. 4 illustrates a parallel processing unit (“PPU”) 400, according to at least one embodiment. The PPU 400 may be used as a component of one or more embodiments of one or more systems disclosed herein or may be used to implement one or more embodiments of one or more methods disclosed herein. In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one example parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

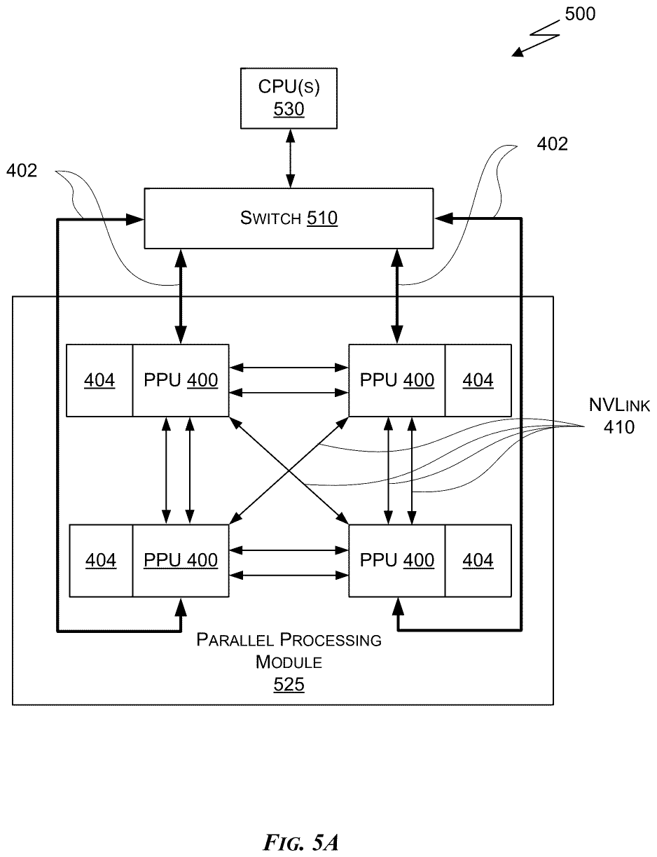

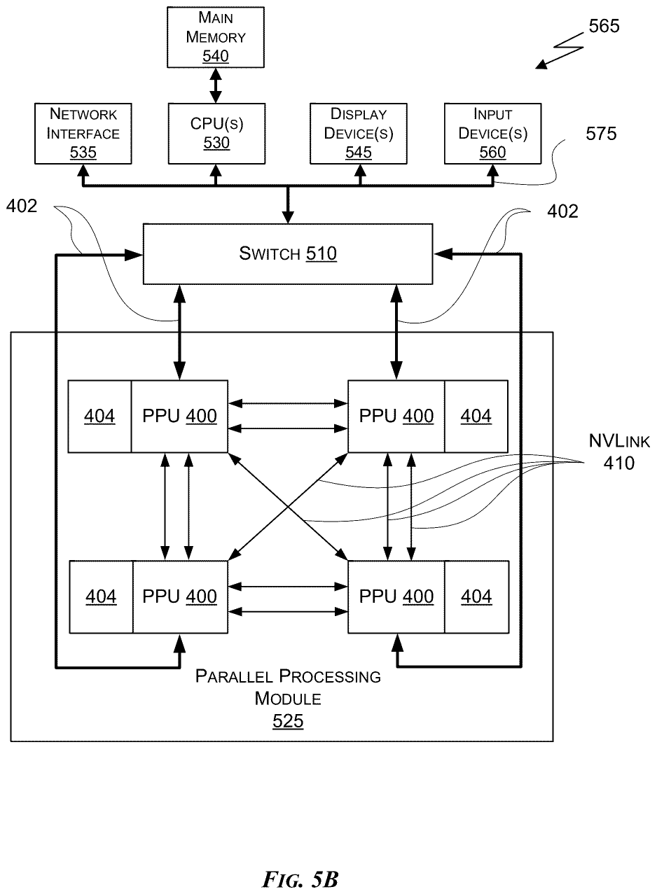

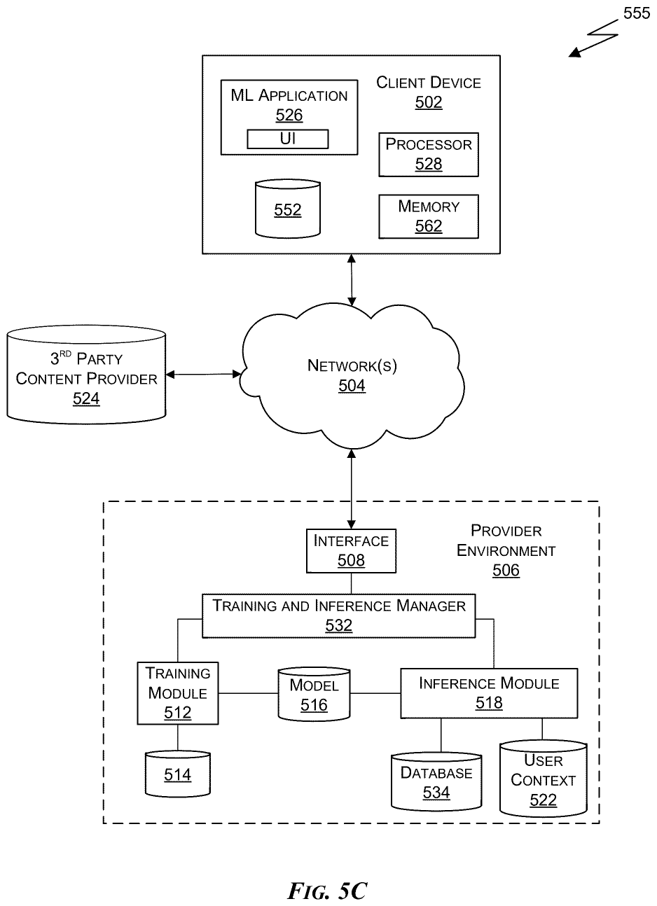

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in an L2 cache, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A illustrates a processing system 500 implemented using the PPU 400 of FIG. 4, according to at least one embodiment. The example system 500 may be used as a component of one or more embodiments of one or more systems disclosed herein or may be used to implement one or more embodiments of one or more systems and methods disclosed herein. The processing system 500 includes a CPU 530, switch 510, and multiple PPUs 400, and respective memories 404. The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an example system 565 in which the various architecture and/or functionality of the various previous embodiments may be implemented, according to at least one embodiment. The example system 565 may be used as a component of one or more embodiments of one or more systems disclosed herein or may be used to implement one or more embodiments of one or more systems and methods disclosed herein. As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or example system 565 of FIG. 5B—e.g., each device may include similar components, features, and/or functionality of the processing system 500 and/or example system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or example system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates an example system 555 that can be used to train a machine learning model, according to at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Example Autonomous Vehicle

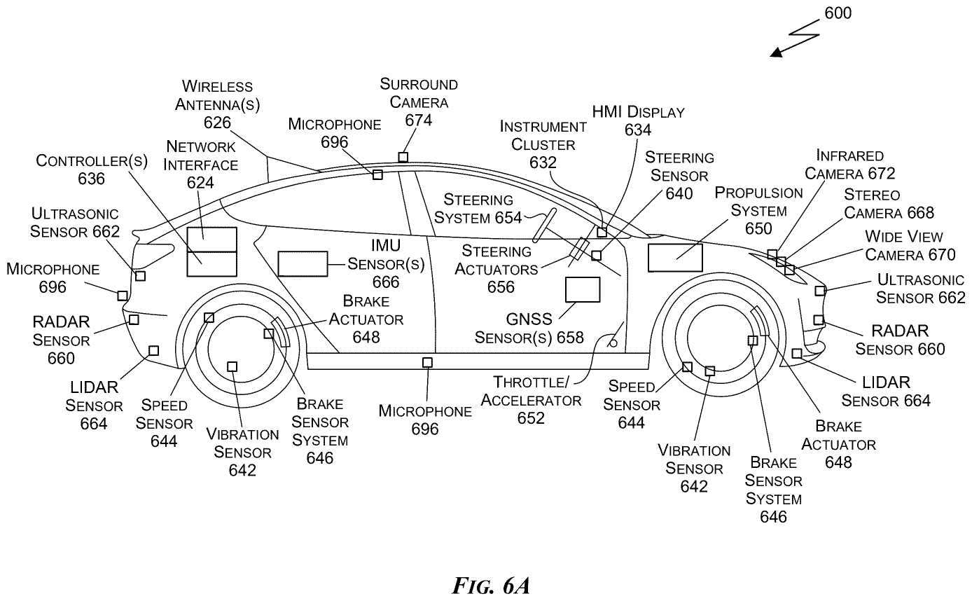

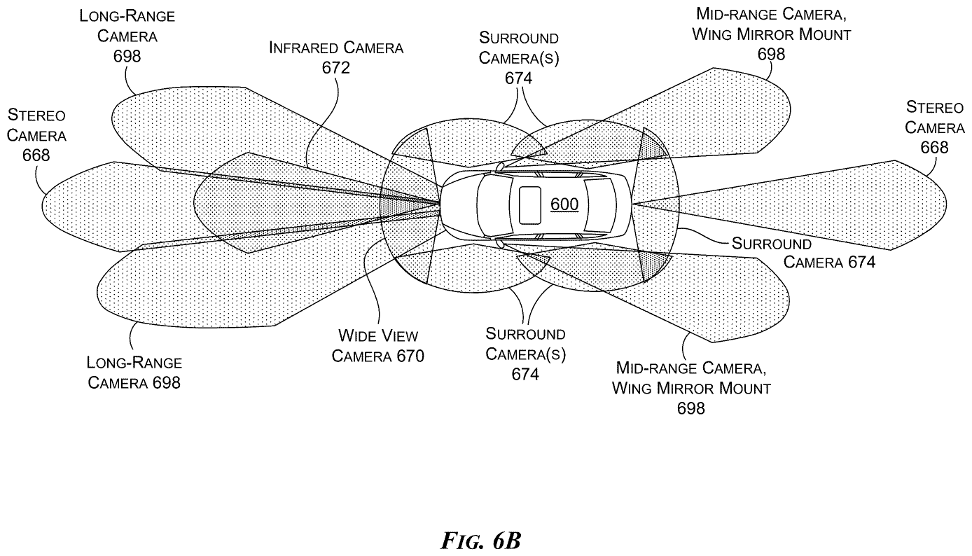

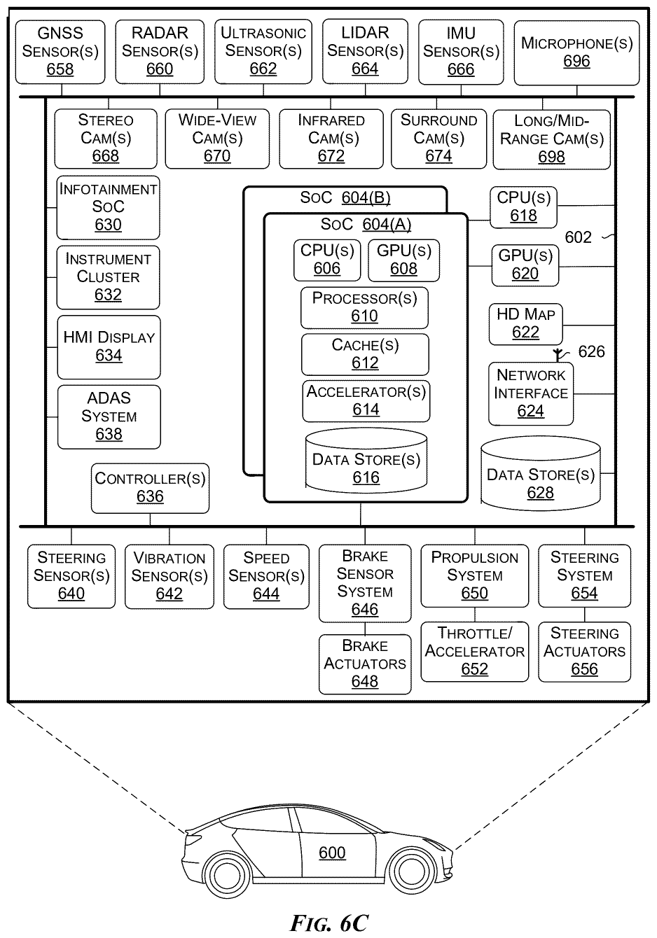

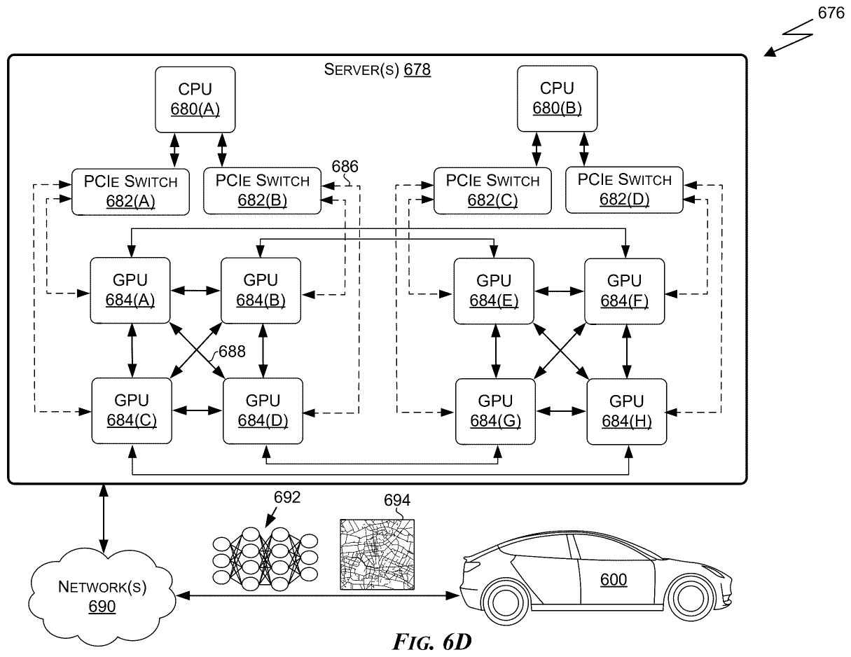

FIG. 6A is an illustration of an example autonomous vehicle 600, in accordance with some embodiments of the present disclosure. The autonomous vehicle 600 (alternatively referred to herein as the “vehicle 600”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, a vehicle coupled to a trailer, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 600 may be capable of functionality in accordance with one or more of Level 3-Level 5 of the autonomous driving levels. The vehicle 600 may be capable of functionality in accordance with one or more of Level 1-Level 5 of the autonomous driving levels. For example, the vehicle 600 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 600 or other machine, such as being fully autonomous, being highly autonomous, being conditionally autonomous, being partially autonomous, providing assistive autonomy, being semi-autonomous, being primarily autonomous, or other designation.

The vehicle 600 may include components such as a chassis, a vehicle body, wheels (e.g., 2, 4, 6, 8, 18, etc.), tires, axles, and other components of a vehicle. The vehicle 600 may include a propulsion system 650, such as an internal combustion engine, hybrid electric power plant, an all-electric engine, and/or another propulsion system type. The propulsion system 650 may be connected to a drive train of the vehicle 600, which may include a transmission, to enable the propulsion of the vehicle 600. The propulsion system 650 may be controlled in response to receiving signals from the throttle/accelerator 652.

A steering system 654, which may include a steering wheel, may be used to steer the vehicle 600 (e.g., along a desired path or route) when the propulsion system 650 is operating (e.g., when the vehicle is in motion). The steering system 654 may receive signals from a steering actuator 656. The steering wheel may be optional for full automation (Level 5) functionality.

The brake sensor system 646 may be used to operate the vehicle brakes in response to receiving signals from the brake actuators 648 and/or brake sensors.

Controller(s) 636, which may include one or more system on chips (SoCs) 604 (FIG. 6C) and/or GPU(s), may provide signals (e.g., representative of commands) to one or more components and/or systems of the vehicle 600. For example, the controller(s) may send signals to operate the vehicle brakes via one or more brake actuators 648, to operate the steering system 654 via one or more steering actuators 656, to operate the propulsion system 650 via one or more throttle/accelerators 652. The controller(s) 636 may include one or more onboard (e.g., integrated) computing devices (e.g., supercomputers) that process sensor signals, and output operation commands (e.g., signals representing commands) to enable autonomous driving and/or to assist a human driver in driving the vehicle 600. The controller(s) 636 may include a first controller 636 for autonomous driving functions, a second controller 636 for functional safety functions, a third controller 636 for artificial intelligence functionality (e.g., computer vision), a fourth controller 636 for infotainment functionality, a fifth controller 636 for redundancy in emergency conditions, and/or other controllers. In some examples, a single controller 636 may handle two or more of the above functionalities, two or more controllers 636 may handle a single functionality, and/or any combination thereof.

The controller(s) 636 may provide the signals for controlling one or more components and/or systems of the vehicle 600 in response to sensor data received from one or more sensors (e.g., sensor inputs). The sensor data may be received from, for example and without limitation, global navigation satellite systems sensor(s) 658 (e.g., Global Positioning System sensor(s)), RADAR sensor(s) 660, ultrasonic sensor(s) 662, LIDAR sensor(s) 664, inertial measurement unit (IMU) sensor(s) 666 (e.g., accelerometer(s), gyroscope(s), magnetic compass(es), magnetometer(s), etc.), microphone(s) 696, stereo camera(s) 668, wide-view camera(s) 670 (e.g., fisheye cameras), infrared camera(s) 672, surround camera(s) 674 (e.g., 360 degree cameras), long-range and/or mid-range camera(s) 698, speed sensor(s) 644 (e.g., for measuring the speed of the vehicle 600), vibration sensor(s) 642, steering sensor(s) 640, brake sensor(s) (e.g., as part of the brake sensor system 646), and/or other sensor types.

One or more of the controller(s) 636 may receive inputs (e.g., represented by input data) from an instrument cluster 632 of the vehicle 600 and provide outputs (e.g., represented by output data, display data, etc.) via a human-machine interface (HMI) display 634, an audible annunciator, a loudspeaker, and/or via other components of the vehicle 600. The outputs may include information such as vehicle velocity, speed, time, map data (e.g., the HD map 622 of FIG. 6C), location data (e.g., the vehicle's 600 location, such as on a map), direction, location of other vehicles (e.g., an occupancy grid), information about objects and status of objects as perceived by the controller(s) 636, etc. For example, the HMI display 634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 600 further includes a network interface 624 which may use one or more wireless antenna(s) 626 and/or modem(s) to communicate over one or more networks. For example, the network interface 624 may be capable of communication over LTE, WCDMA, UMTS, GSM, CDMA2000, etc. The wireless antenna(s) 626 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 6B is an example of camera locations and fields of view for the example autonomous vehicle 600 of FIG. 6A, in accordance with some embodiments of the present disclosure. The cameras and respective fields of view are one example embodiment and are not intended to be limiting. For example, additional and/or alternative cameras may be included and/or the cameras may be located at different locations on the vehicle 600.

The camera types for the cameras may include, but are not limited to, digital cameras that may be adapted for use with the components and/or systems of the vehicle 600. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 600 (e.g., front-facing cameras) may be used for surround view, to help identify forward facing paths and obstacles, as well aid in, with the help of one or more controllers 636 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 670 that may be used to perceive objects coming into view from the periphery (e.g., pedestrians, crossing traffic or bicycles). Although only one wide-view camera is illustrated in FIG. 6B, there may any number of wide-view cameras 670 on the vehicle 600. In addition, long-range camera(s) 698 (e.g., a long-view stereo camera pair) may be used for depth-based object detection, especially for objects for which a neural network has not yet been trained. The long-range camera(s) 698 may also be used for object detection and classification, as well as basic object tracking.

One or more stereo cameras 668 may also be included in a front-facing configuration. The stereo camera(s) 668 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 668 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 668 may be used in addition to, or alternatively from, those described herein.

Cameras with a field of view that include portions of the environment to the side of the vehicle 600 (e.g., side-view cameras) may be used for surround view, providing information used to create and update the occupancy grid, as well as to generate side impact collision warnings. For example, surround camera(s) 674 (e.g., four surround cameras 674 as illustrated in FIG. 6B) may be positioned to on the vehicle 600. The surround camera(s) 674 may include wide-view camera(s) 670, fisheye camera(s), 360 degree camera(s), and/or the like. Four example, four fisheye cameras may be positioned on the vehicle's front, rear, and sides. In an alternative arrangement, the vehicle may use three surround camera(s) 674 (e.g., left, right, and rear), and may leverage one or more other camera(s) (e.g., a forward-facing camera) as a fourth surround view camera.

Cameras with a field of view that include portions of the environment to the rear of the vehicle 600 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 698, stereo camera(s) 668), infrared camera(s) 672, etc.), as described herein.

FIG. 6C is a block diagram of an example system architecture for the example autonomous vehicle 600 of FIG. 6A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 600 in FIG. 6C are illustrated as being connected via bus 602. The bus 602 may include a Controller Area Network (CAN) data interface (alternatively referred to herein as a “CAN bus”). A CAN may be a network inside the vehicle 600 used to aid in control of various features and functionality of the vehicle 600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 602 is described herein as being a CAN bus, this is not intended to be limiting. For example, in addition to, or alternatively from, the CAN bus, FlexRay and/or Ethernet may be used. Additionally, although a single line is used to represent the bus 602, this is not intended to be limiting. For example, there may be any number of busses 602, which may include one or more CAN busses, one or more FlexRay busses, one or more Ethernet busses, and/or one or more other types of busses using a different protocol. In some examples, two or more busses 602 may be used to perform different functions, and/or may be used for redundancy. For example, a first bus 602 may be used for collision avoidance functionality and a second bus 602 may be used for actuation control. In any example, each bus 602 may communicate with any of the components of the vehicle 600, and two or more busses 602 may communicate with the same components. In some examples, each SoC 604, each controller 636, and/or each computer within the vehicle may have access to the same input data (e.g., inputs from sensors of the vehicle 600), and may be connected to a common bus, such the CAN bus.

The vehicle 600 may include one or more controller(s) 636, such as those described herein with respect to FIG. 6A. The controller(s) 636 may be used for a variety of functions. The controller(s) 636 may be coupled to any of the various other components and systems of the vehicle 600, and may be used for control of the vehicle 600, artificial intelligence of the vehicle 600, infotainment for the vehicle 600, and/or the like.

The vehicle 600 may include a system(s) on a chip (SoC) 604. The SoC 604 may include CPU(s) 606, GPU(s) 608, processor(s) 610, cache(s) 612, accelerator(s) 614, data store(s) 616, and/or other components and features not illustrated. The SoC(s) 604 may be used to control the vehicle 600 in a variety of platforms and systems. For example, the SoC(s) 604 may be combined in a system (e.g., the system of the vehicle 600) with an HD map 622 which may obtain map refreshes and/or updates via a network interface 624 from one or more servers (e.g., server(s) 678 of FIG. 6D).

The CPU(s) 606 may include a CPU cluster or CPU complex (alternatively referred to herein as a “CCPLEX”). The CPU(s) 606 may include multiple cores and/or L2 caches. For example, in some embodiments, the CPU(s) 606 may include eight cores in a coherent multi-processor configuration. In some embodiments, the CPU(s) 606 may include four dual-core clusters where each cluster has a dedicated L2 cache (e.g., a 2 MB L2 cache). The CPU(s) 606 (e.g., the CCPLEX) may be configured to support simultaneous cluster operation enabling any combination of the clusters of the CPU(s) 606 to be active at any given time.

The CPU(s) 606 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 606 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 608 may include an integrated GPU (alternatively referred to herein as an “iGPU”). The GPU(s) 608 may be programmable and may be efficient for parallel workloads. The GPU(s) 608, in some examples, may use an enhanced tensor instruction set. The GPU(s) 608 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 608 may include at least eight streaming microprocessors. The GPU(s) 608 may use compute application programming interface(s) (API(s)). In addition, the GPU(s) 608 may use one or more parallel computing platforms and/or programming models (e.g., NVIDIA's CUDA).

The GPU(s) 608 may be power-optimized for best performance in automotive and embedded use cases. For example, the GPU(s) 608 may be fabricated on a Fin field-effect transistor (FinFET). However, this is not intended to be limiting and the GPU(s) 608 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 608 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 608 to access the CPU(s) 606 page tables directly. In such examples, when the GPU(s) 608 memory management unit (MMU) experiences a miss, an address translation request may be transmitted to the CPU(s) 606. In response, the CPU(s) 606 may look in its page tables for the virtual-to-physical mapping for the address and transmits the translation back to the GPU(s) 608. As such, unified memory technology may allow a single unified virtual address space for memory of both the CPU(s) 606 and the GPU(s) 608, thereby simplifying the GPU(s) 608 programming and porting of applications to the GPU(s) 608.

In addition, the GPU(s) 608 may include an access counter that may keep track of the frequency of access of the GPU(s) 608 to memory of other processors. The access counter may help ensure that memory pages are moved to the physical memory of the processor that is accessing the pages most frequently.

The SoC(s) 604 may include any number of cache(s) 612, including those described herein. For example, the cache(s) 612 may include an L3 cache that is available to both the CPU(s) 606 and the GPU(s) 608 (e.g., that is connected both the CPU(s) 606 and the GPU(s) 608). The cache(s) 612 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 604 may include an arithmetic logic unit(s) (ALU(s)) which may be leveraged in performing processing with respect to any of the variety of tasks or operations of the vehicle 600—such as processing DNNs. In addition, the SoC(s) 604 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 606 and/or GPU(s) 608.

The SoC(s) 604 may include one or more accelerators 614 (e.g., hardware accelerators, software accelerators, or a combination thereof). For example, the SoC(s) 604 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 608 and to off-load some of the tasks of the GPU(s) 608 (e.g., to free up more cycles of the GPU(s) 608 for performing other tasks). As an example, the accelerator(s) 614 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 614 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 608, and by using an inference accelerator, for example, a designer may target either the DLA(s) or the GPU(s) 608 for any function. For example, the designer may focus processing of CNNs and floating point operations on the DLA(s) and leave other functions to the GPU(s) 608 and/or other accelerator(s) 614.

The accelerator(s) 614 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 606. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 614 (e.g., the hardware acceleration cluster) may include a computer vision network on-chip and SRAM, for providing a high-bandwidth, low latency SRAM for the accelerator(s) 614. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 604 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 614 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 666 output that correlates with the vehicle 600 orientation, distance, 3D location estimates of the object obtained from the neural network and/or other sensors (e.g., LIDAR sensor(s) 664 or RADAR sensor(s) 660), among others.

The SoC(s) 604 may include data store(s) 616 (e.g., memory). The data store(s) 616 may be on-chip memory of the SoC(s) 604, which may store neural networks to be executed on the GPU and/or the DLA. In some examples, the data store(s) 616 may be large enough in capacity to store multiple instances of neural networks for redundancy and safety. The data store(s) 612 may comprise L2 or L3 cache(s) 612. Reference to the data store(s) 616 may include reference to the memory associated with the PVA, DLA, and/or other accelerator(s) 614, as described herein.

The SoC(s) 604 may include one or more processor(s) 610 (e.g., embedded processors). The processor(s) 610 may include a boot and power management processor that may be a dedicated processor and subsystem to handle boot power and management functions and related security enforcement. The boot and power management processor may be a part of the SoC(s) 604 boot sequence and may provide runtime power management services. The boot power and management processor may provide clock and voltage programming, assistance in system low power state transitions, management of SoC(s) 604 thermals and temperature sensors, and/or management of the SoC(s) 604 power states. Each temperature sensor may be implemented as a ring-oscillator whose output frequency is proportional to temperature, and the SoC(s) 604 may use the ring-oscillators to detect temperatures of the CPU(s) 606, GPU(s) 608, and/or accelerator(s) 614. If temperatures are determined to exceed a threshold, the boot and power management processor may enter a temperature fault routine and put the SoC(s) 604 into a lower power state and/or put the vehicle 600 into a chauffeur to safe stop mode (e.g., bring the vehicle 600 to a safe stop).

The processor(s) 610 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 610 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 610 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 610 may further include a real-time camera engine that may include a dedicated processor subsystem for handling real-time camera management.

The processor(s) 610 may further include a high-dynamic range signal processor that may include an image signal processor that is a hardware engine that is part of the camera processing pipeline.

The processor(s) 610 may include a video image compositor that may be a processing block (e.g., implemented on a microprocessor) that implements video post-processing functions needed by a video playback application to produce the final image for the player window. The video image compositor may perform lens distortion correction on wide-view camera(s) 670, surround camera(s) 674, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 608 is not required to continuously render new surfaces. Even when the GPU(s) 608 is powered on and active doing 3D rendering, the video image compositor may be used to offload the GPU(s) 608 to improve performance and responsiveness.

The SoC(s) 604 may further include a mobile industry processor interface (MIPI) camera serial interface for receiving video and input from cameras, a high-speed interface, and/or a video input block that may be used for camera and related pixel input functions. The SoC(s) 604 may further include an input/output controller(s) that may be controlled by software and may be used for receiving I/O signals that are uncommitted to a specific role.

The SoC(s) 604 may further include a broad range of peripheral interfaces to enable communication with peripherals, audio codecs, power management, and/or other devices. The SoC(s) 604 may be used to process data from cameras (e.g., connected over Gigabit Multimedia Serial Link and Ethernet), sensors (e.g., LIDAR sensor(s) 664, RADAR sensor(s) 660, etc. that may be connected over Ethernet), data from bus 602 (e.g., speed of vehicle 600, steering wheel position, etc.), data from GNSS sensor(s) 658 (e.g., connected over Ethernet or CAN bus). The SoC(s) 604 may further include dedicated high-performance mass storage controllers that may include their own DMA engines, and that may be used to free the CPU(s) 606 from routine data management tasks.

The SoC(s) 604 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 604 may be faster, more reliable, and even more energy-efficient and space-efficient than conventional systems. For example, the accelerator(s) 614, when combined with the CPU(s) 606, the GPU(s) 608, and the data store(s) 616, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 620) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 608.

In some examples, a CNN for facial recognition and vehicle owner identification may use data from camera sensors to identify the presence of an authorized driver and/or owner of the vehicle 600. The always on sensor processing engine may be used to unlock the vehicle when the owner approaches the driver door and turn on the lights, and, in security mode, to disable the vehicle when the owner leaves the vehicle. In this way, the SoC(s) 604 provide for security against theft and/or carjacking.

In another example, a CNN for emergency vehicle detection and identification may use data from microphones 696 to detect and identify emergency vehicle sirens. In contrast to conventional systems, that use general classifiers to detect sirens and manually extract features, the SoC(s) 604 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 658. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 662, until the emergency vehicle(s) passes.

The vehicle may include a CPU(s) 618 (e.g., discrete CPU(s), or dCPU(s)), that may be coupled to the SoC(s) 604 via a high-speed interconnect (e.g., PCIe). The CPU(s) 618 may include an X86 processor, for example. The CPU(s) 618 may be used to perform any of a variety of functions, including arbitrating potentially inconsistent results between ADAS sensors and the SoC(s) 604, and/or monitoring the status and health of the controller(s) 636 and/or infotainment SoC 630, for example.

The vehicle 600 may include a GPU(s) 620 (e.g., discrete GPU(s), or dGPU(s)), that may be coupled to the SoC(s) 604 via a high-speed interconnect (e.g., NVIDIA's NVLINK). The GPU(s) 620 may provide additional artificial intelligence functionality, such as by executing redundant and/or different neural networks, and may be used to train and/or update neural networks based on input (e.g., sensor data) from sensors of the vehicle 600.

The vehicle 600 may further include the network interface 624 which may include one or more wireless antennas 626 (e.g., one or more wireless antennas for different communication protocols, such as a cellular antenna, a Bluetooth antenna, etc.). The network interface 624 may be used to enable wireless connectivity over the Internet with the cloud (e.g., with the server(s) 678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 600 information about vehicles in proximity to the vehicle 600 (e.g., vehicles in front of, on the side of, and/or behind the vehicle 600). This functionality may be part of a cooperative adaptive cruise control functionality of the vehicle 600.

The network interface 624 may include a SoC that provides modulation and demodulation functionality and enables the controller(s) 636 to communicate over wireless networks. The network interface 624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 600 may further include data store(s) 628 which may include off-chip (e.g., off the SoC(s) 604) storage. The data store(s) 628 may include one or more storage elements including RAM, SRAM, DRAM, VRAM, Flash, hard disks, and/or other components and/or devices that may store at least one bit of data.

The vehicle 600 may further include GNSS sensor(s) 658. The GNSS sensor(s) 658 (e.g., GPS, assisted GPS sensors, differential GPS (DGPS) sensors, etc.), to assist in mapping, perception, occupancy grid generation, and/or path planning functions. Any number of GNSS sensor(s) 658 may be used, including, for example and without limitation, a GPS using a USB connector with an Ethernet to Serial (RS-232) bridge.

The vehicle 600 may further include RADAR sensor(s) 660. The RADAR sensor(s) 660 may be used by the vehicle 600 for long-range vehicle detection, even in darkness and/or severe weather conditions. RADAR functional safety levels may be ASIL B. The RADAR sensor(s) 660 may use the CAN and/or the bus 602 (e.g., to transmit data generated by the RADAR sensor(s) 660) for control and to access object tracking data, with access to Ethernet to access raw data in some examples. A wide variety of RADAR sensor types may be used. For example, and without limitation, the RADAR sensor(s) 660 may be suitable for front, rear, and side RADAR use. In some example, Pulse Doppler RADAR sensor(s) are used.

The RADAR sensor(s) 660 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 660 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 600 surroundings at higher speeds with minimal interference from traffic in adjacent lanes. The other two antennae may expand the field of view, making it possible to quickly detect vehicles entering or leaving the vehicle's 600 lane.

Mid-range RADAR systems may include, as an example, a range of up to 660 m (front) or 80 m (rear), and a field of view of up to 42 degrees (front) or 650 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 600 may further include ultrasonic sensor(s) 662. The ultrasonic sensor(s) 662, which may be positioned at the front, back, and/or the sides of the vehicle 600, may be used for park assist and/or to create and update an occupancy grid. A wide variety of ultrasonic sensor(s) 662 may be used, and different ultrasonic sensor(s) 662 may be used for different ranges of detection (e.g., 2.5 m, 4 m). The ultrasonic sensor(s) 662 may operate at functional safety levels of ASIL B.

The vehicle 600 may include LIDAR sensor(s) 664. The LIDAR sensor(s) 664 may be used for object and pedestrian detection, emergency braking, collision avoidance, and/or other functions. The LIDAR sensor(s) 664 may be functional safety level ASIL B. In some examples, the vehicle 600 may include multiple LIDAR sensors 664 (e.g., two, four, six, etc.) that may use Ethernet (e.g., to provide data to a Gigabit Ethernet switch).

In some examples, the LIDAR sensor(s) 664 may be capable of providing a list of objects and their distances for a 360-degree field of view. Commercially available LIDAR sensor(s) 664 may have an advertised range of approximately 600 m, with an accuracy of 2 cm-3 cm, and with support for a 600 Mbps Ethernet connection, for example. In some examples, one or more non-protruding LIDAR sensors 664 may be used. In such examples, the LIDAR sensor(s) 664 may be implemented as a small device that may be embedded into the front, rear, sides, and/or corners of the vehicle 600. The LIDAR sensor(s) 664, in such examples, may provide up to a 120-degree horizontal and 35-degree vertical field-of-view, with a 200 m range even for low-reflectivity objects. Front-mounted LIDAR sensor(s) 664 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 600. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 664 may be less susceptible to motion blur, vibration, and/or shock.

The vehicle may further include IMU sensor(s) 666. The IMU sensor(s) 666 may be located at a center of the rear axle of the vehicle 600, in some examples. The IMU sensor(s) 666 may include, for example and without limitation, an accelerometer(s), a magnetometer(s), a gyroscope(s), a magnetic compass(es), and/or other sensor types. In some examples, such as in six-axis applications, the IMU sensor(s) 666 may include accelerometers and gyroscopes, while in nine-axis applications, the IMU sensor(s) 666 may include accelerometers, gyroscopes, and magnetometers.

In some embodiments, the IMU sensor(s) 666 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 666 may enable the vehicle 600 to estimate heading without requiring input from a magnetic sensor by directly observing and correlating the changes in velocity from GPS to the IMU sensor(s) 666. In some examples, the IMU sensor(s) 666 and the GNSS sensor(s) 658 may be combined in a single integrated unit.

The vehicle may include microphone(s) 696 placed in and/or around the vehicle 600. The microphone(s) 696 may be used for emergency vehicle detection and identification, among other things.

The vehicle may further include any number of camera types, including stereo camera(s) 668, wide-view camera(s) 670, infrared camera(s) 672, surround camera(s) 674, long-range and/or mid-range camera(s) 698, and/or other camera types. The cameras may be used to capture image data around an entire periphery of the vehicle 600. The types of cameras used depends on the embodiments and requirements for the vehicle 600, and any combination of camera types may be used to provide the necessary coverage around the vehicle 600. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 6A and FIG. 6B.

The vehicle 600 may further include vibration sensor(s) 642. The vibration sensor(s) 642 may measure vibrations of components of the vehicle, such as the axle(s). For example, changes in vibrations may indicate a change in road surfaces. In another example, when two or more vibration sensors 642 are used, the differences between the vibrations may be used to determine friction or slippage of the road surface (e.g., when the difference in vibration is between a power-driven axle and a freely rotating axle).

The vehicle 600 may include an ADAS system 638. The ADAS system 638 may include a SoC, in some examples. The ADAS system 638 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 660, LIDAR sensor(s) 664, and/or a camera(s). The ACC systems may include longitudinal ACC and/or lateral ACC. Longitudinal ACC monitors and controls the distance to the vehicle immediately ahead of the vehicle 600 and automatically adjust the vehicle speed to maintain a safe distance from vehicles ahead. Lateral ACC performs distance keeping, and advises the vehicle 600 to change lanes when necessary. Lateral ACC is related to other ADAS applications such as LCA and CWS.

CACC uses information from other vehicles that may be received via the network interface 624 and/or the wireless antenna(s) 626 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 600), while the I2V communication concept provides information about traffic further ahead. CACC systems may include either or both I2V and V2V information sources. Given the information of the vehicles ahead of the vehicle 600, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 660, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 660, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 600 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 600 if the vehicle 600 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 660, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 600 is backing up. Some RCTW systems include AEB to ensure that the vehicle brakes are applied to avoid a crash. RCTW systems may use one or more rear-facing RADAR sensor(s) 660, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 600, the vehicle 600 itself must, in the case of conflicting results, decide whether to heed the result from a primary computer or a secondary computer (e.g., a first controller 636 or a second controller 636). For example, in some embodiments, the ADAS system 638 may be a backup and/or secondary computer for providing perception information to a backup computer rationality module. The backup computer rationality monitor may run a redundant diverse software on hardware components to detect faults in perception and dynamic driving tasks. Outputs from the ADAS system 638 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 604.

In other examples, ADAS system 638 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 638 may be fed into the primary computer's perception block and/or the primary computer's dynamic driving task block. For example, if the ADAS system 638 indicates a forward crash warning due to an object immediately ahead, the perception block may use this information when identifying objects. In other examples, the secondary computer may have its own neural network which is trained and thus reduces the risk of false positives, as described herein.

The vehicle 600 may further include the infotainment SoC 630 (e.g., an in-vehicle infotainment system (IVI)). Although illustrated and described as a SoC, the infotainment system may not be a SoC, and may include two or more discrete components. The infotainment SoC 630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 600. For example, the infotainment SoC 630 may radios, disk players, navigation systems, video players, USB and Bluetooth connectivity, carputers, in-car entertainment, Wi-Fi, steering wheel audio controls, hands free voice control, a heads-up display (HUD), an HMI display 634, a telematics device, a control panel (e.g., for controlling and/or interacting with various components, features, and/or systems), and/or other components. The infotainment SoC 630 may further be used to provide information (e.g., visual and/or audible) to a user(s) of the vehicle, such as information from the ADAS system 638, autonomous driving information such as planned vehicle maneuvers, trajectories, surrounding environment information (e.g., intersection information, vehicle information, road information, etc.), and/or other information.

The infotainment SoC 630 may include GPU functionality. The infotainment SoC 630 may communicate over the bus 602 (e.g., CAN bus, Ethernet, etc.) with other devices, systems, and/or components of the vehicle 600. In some examples, the infotainment SoC 630 may be coupled to a supervisory MCU such that the GPU of the infotainment system may perform some self-driving functions in the event that the primary controller(s) 636 (e.g., the primary and/or backup computers of the vehicle 600) fail. In such an example, the infotainment SoC 630 may put the vehicle 600 into a chauffeur to safe stop mode, as described herein.

The vehicle 600 may further include an instrument cluster 632 (e.g., a digital dash, an electronic instrument cluster, a digital instrument panel, etc.). The instrument cluster 632 may include a controller and/or supercomputer (e.g., a discrete controller or supercomputer). The instrument cluster 632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 630 and the instrument cluster 632. In other words, the instrument cluster 632 may be included as part of the infotainment SoC 630, or vice versa.

FIG. 6D is a system diagram for communication between cloud-based server(s) and the example autonomous vehicle 600 of FIG. 6A, in accordance with some embodiments of the present disclosure. The system 676 may include server(s) 678, network(s) 690, and vehicles, including the vehicle 600. The server(s) 678 may include a plurality of GPUs 684(A)-684(H) (collectively referred to herein as GPUs 684), PCIe switches 682(A)-682(H) (collectively referred to herein as PCIe switches 682), and/or CPUs 680(A)-680(B) (collectively referred to herein as CPUs 680). The GPUs 684, the CPUs 680, and the PCIe switches may be interconnected with high-speed interconnects such as, for example and without limitation, NVLink interfaces 688 developed by NVIDIA and/or PCIe connections 686. In some examples, the GPUs 684 are connected via NVLink and/or NVSwitch SoC and the GPUs 684 and the PCIe switches 682 are connected via PCIe interconnects. Although eight GPUs 684, two CPUs 680, and two PCIe switches are illustrated, this is not intended to be limiting. Depending on the embodiment, each of the server(s) 678 may include any number of GPUs 684, CPUs 680, and/or PCIe switches. For example, the server(s) 678 may each include eight, sixteen, thirty-two, and/or more GPUs 684.

The server(s) 678 may receive, over the network(s) 690 and from the vehicles, image data representative of images showing unexpected or changed road conditions, such as recently commenced road-work. The server(s) 678 may transmit, over the network(s) 690 and to the vehicles, neural networks 692, updated neural networks 692, and/or map information 694, including information regarding traffic and road conditions. The updates to the map information 694 may include updates for the HD map 622, such as information regarding construction sites, potholes, detours, flooding, and/or other obstructions. In some examples, the neural networks 692, the updated neural networks 692, and/or the map information 694 may have resulted from new training and/or experiences represented in data received from any number of vehicles in the environment, and/or based on training performed at a datacenter (e.g., using the server(s) 678 and/or other servers).

The server(s) 678 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 690, and/or the machine learning models may be used by the server(s) 678 to remotely monitor the vehicles.

In some examples, the server(s) 678 may receive data from the vehicles and apply the data to up-to-date real-time neural networks for real-time intelligent inferencing. The server(s) 678 may include deep-learning supercomputers and/or dedicated AI computers powered by GPU(s) 684, such as a DGX and DGX Station machines developed by NVIDIA. However, in some examples, the server(s) 678 may include deep learning infrastructure that use only CPU-powered datacenters.

The deep-learning infrastructure of the server(s) 678 may be capable of fast, real-time inferencing, and may use that capability to evaluate and verify the health of the processors, software, and/or associated hardware in the vehicle 600. For example, the deep-learning infrastructure may receive periodic updates from the vehicle 600, such as a sequence of images and/or objects that the vehicle 600 has located in that sequence of images (e.g., via computer vision and/or other machine learning object classification techniques). The deep-learning infrastructure may run its own neural network to identify the objects and compare them with the objects identified by the vehicle 600 and, if the results do not match and the infrastructure concludes that the AI in the vehicle 600 is malfunctioning, the server(s) 678 may transmit a signal to the vehicle 600 instructing a fail-safe computer of the vehicle 600 to assume control, notify the passengers, and complete a safe parking maneuver.

For inferencing, the server(s) 678 may include the GPU(s) 684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

One or more embodiments of the disclosure may be described in the general context of computer code or machine-useable instructions, including computer-executable instructions such as program modules, being executed by a computer or other machine. Generally, program modules, e.g., including routines, programs, objects, components, data structures, etc., refer to code that performs particular tasks or implements particular data types. One or more embodiments of the disclosure may be practiced in a variety of system configurations, including, e.g., hand-held devices, consumer electronics, general-purpose computers, more specialty computing devices, etc. One or more embodiments of the disclosure may also be practiced in distributed computing environments where tasks are performed by remote-processing devices that are linked through a communications network.

Operations of processes described herein can be performed in any suitable order unless otherwise explicitly indicated herein or otherwise clearly contradicted by context. In at least one embodiment, a process, such as described herein (or variations and/or combinations thereof), is performed under control of one or more computer systems configured with executable instructions and is implemented as code (e.g., executable instructions, one or more computer programs, or one or more applications) executing collectively on one or more processors. In at least one embodiment, code is stored on computer-readable storage media, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, computer-readable storage media comprises multiple non-transitory computer-readable storage media, and one or more individual non-transitory storage media of the multiple non-transitory computer-readable storage media lack all code while the multiple non-transitory computer-readable storage media collectively store all of code. In at least one embodiment, executable instructions are executed such that different instructions are executed by different processors—for example, non-transitory computer-readable storage media store instructions and a main central processing unit (“CPU”) executes some of the instructions while a graphics processing unit (“GPU”) executes others of the instructions. In at least one embodiment, different components of a computer system have separate processors and different processors execute different subsets of instructions.

In at least one embodiment, as a result of processing an instruction retrieved by the processor, the processor presents one or more inputs or operands to an arithmetic logic unit (ALU), causing the ALU to produce a result based at least in part on an instruction code provided to inputs of the arithmetic logic unit. In at least one embodiment, the instruction codes provided by the processor to the ALU are based at least in part on the instruction executed by the processor. In at least one embodiment, combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term “arithmetic logic unit,” or “ALU,” may be used to refer to any computational logic circuit that processes operands to produce a result. For example, in the present document, the term ALU can refer to a floating point unit, a digital signal processor (DSP), a tensor core, a shader core, a coprocessor, or a CPU. In at least one embodiment, an ALU is a set of combinational logic circuitry that takes one or more inputs to produce a result. In at least one embodiment, an ALU is used by a processor to implement mathematical operation such as addition, subtraction, or multiplication. In at least one embodiment, an ALU is used to implement logical operations such as logical AND/OR or XOR. In at least one embodiment, an ALU is stateless, and made from physical switching components such as semiconductor transistors arranged to form logical gates. In at least one embodiment, an ALU may operate internally as a stateful logic circuit with an associated clock. In at least one embodiment, an ALU may be constructed as an asynchronous logic circuit with an internal state not maintained in an associated register set. In at least one embodiment, an ALU is used by a processor to combine operands stored in one or more registers of the processor and produce an output that can be stored by the processor in another register or a memory location.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as systems may embody one or more methods and methods may be considered a system.

Use of any and all examples, or exemplary language (e.g., “such as”) provided herein, is intended merely to better illuminate embodiments of the disclosure and does not pose a limitation on scope of disclosure unless otherwise explicitly stated. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In the description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but still co-operate or interact with each other.

Unless specifically stated otherwise, it may be appreciated that throughout the specification terms such as “processing,” “computing,” “calculating,” “determining,” or the like, refer to action and/or processes of a computer or computing system, or similar electronic computing device, that manipulate and/or transform data represented as physical, such as electronic, quantities within registers and/or memories into other data similarly represented as physical quantities within memories, registers or other such information storage, transmission, or display devices.

In the present the document, references may be made to obtaining, acquiring, receiving, or inputting analog or digital data into a subsystem, computer system, or computer-implemented machine. In at least one embodiment, processes of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances. In addition, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

Use of terms “a” and “an” and “the” and similar referents in context of describing disclosed embodiments (especially in context of the following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within a range, unless otherwise indicated herein, and each separate value is incorporated into the specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B or C,” unless specifically stated otherwise or otherwise clearly contradicted by context, is understood with context as used in general to present that an item, term, etc., may be either A or B or C, or any nonempty subset of set of A and B and C. For instance, in illustrative an example of a set having three members, conjunctive phrases “at least one of A, B, and C” and “at least one of A, B or C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more, e.g., when so indicated either explicitly or by context. Further, unless stated otherwise or otherwise clear from context, the phrase “based on” means “based at least in part on” and not “based solely on.”

The foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. For example, the phrase “based on” is intended to mean “based at least in part on” and not “based solely on.” No language in the specification should be construed as indicating any non-claimed element as essential to the practice of the invention as claimed.

What is claimed is:

1. A method comprising:
obtaining sample 4D point clouds, each respective sample 4D point cloud representing a respective scene for a respective period;
labeling the sample 4D point clouds with target labels; and
training a segmentation model by performing, for one or more training iterations:
generating predicted labels using the one or more neural networks based on a sample 4D point cloud,
computing one or more losses based on the predicted labels and the target labels, and
updating, based on the one or more losses, one or more parameters of the one or more neural networks.

2. The method of claim 1, wherein the labeling the sample 4D point clouds with target labels comprises, for a respective sample 4D point cloud:
temporally partitioning the 4D point cloud into a plurality of overlapping windows;
performing, for each respective window of multiple windows of the plurality of overlapping windows:
segmenting one or more video clips corresponding to the respective window to generate one or more sets of video space masks for the respective window, the one or more video clips representing the scene represented by the respective sample 4D point cloud, and
generating 4D point cloud masks for the respective window, the generating the 4D point cloud masks comprising extracting the one or more sets of video space masks from a video space to a 4D point cloud space corresponding to the 4D point cloud; and
generating the target labels, the generating the target labels comprising correlating 4D point cloud masks for single object instances across the multiple windows.

3. The method of claim 2, wherein the performing, for each respective window of multiple windows of the plurality of overlapping windows further comprises extracting semantic features for one or more video space masks of the one or more sets of video space masks for the respective window, and
wherein the target labels include embedding vectors corresponding to single object instances formed by averaging extracted semantic features across the multiple windows.

4. The method of claim 2, wherein extracting the video space masks to the 4D point cloud space comprises projecting each mask into a coordinate frame of the 4D point cloud using calibration data associated with one or more LiDAR sensors via which data for the 4D point cloud was obtained and calibration data associated with one or more cameras via which the one or more video clips were obtained.

5. The method of claim 2, the generating the 4D point cloud masks for the respective window further comprising refining extracted masks by applying density-based spatial clustering.

6. The method of claim 2, the generating the 4D point cloud masks for the respective window further comprising flattening overlapping masks.

7. The method according to claim 6, the flattening overlapping masks comprising ranking masks according to a number of labeled points.

8. The method of claim 2, the correlating 4D point cloud masks for single object instances across the multiple windows comprising applying a linear assignment solver to match object instances between overlapping windows based on spatial overlap and semantic similarity.

9. The method of claim 3, wherein the embedding vectors corresponding to single object instances are vocabulary-agnostic semantic feature vectors produced by a vision-language encoder.

10. The method of claim 1, wherein the one or more neural networks comprise:
a 4D encoder-decoder network to process 4D point clouds and produce feature tensors; and
a transformer decoder to process learnable queries, based on the feature tensors, to generate the predicted labels.

11. The method of claim 10, wherein the predicted labels comprise binary segmentation masks and corresponding feature embeddings.

12. The method of claim 11, wherein the 4D panoptic segmentation model includes the 4D encoder-decoder network, the transformer decoder, and a class vocabulary encoder to process a class vocabulary and generate class embeddings.

13. The method of claim 12, wherein the 4D panoptic segmentation model further includes a projection and semantic matching configured to project the binary segmentation masks onto 4D point clouds and to perform cosine similarity scoring between object instance feature embeddings and class embeddings.

14. The method of claim 1, wherein the method is performed by at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets;
a system implemented at least partially using cloud computing resources;
a system using or deploying one or more inference microservices; or
a system that incorporates one or more machine learning models deployed in a service or microservice along with an OS-level virtualization package.

15. A system, comprising:
one or more processors to perform panoptic segmentation of 4D point clouds using one or more neural networks trained, at least in part, by:
obtaining sample 4D point clouds, each respective sample 4D point cloud representing a respective scene for a respective period;
labeling the sample 4D point clouds with target labels; and
performing, for one or more training iterations:
generating predicted labels using the one or more neural networks based on a sample 4D point cloud
computing one or more losses based on the predicted labels and the target labels, and
updating, based on the one or more losses, parameters of the one or more neural networks; and
one or more memories to store parameters corresponding to the one or more neural networks.

16. The system of claim 15, wherein the labeling the sample 4D point clouds with target labels comprises, for a respective sample 4D point cloud:
temporally partitioning the 4D point cloud into a plurality of overlapping windows;
performing, for each respective window of multiple windows of the plurality of overlapping windows:
segmenting one or more video clips corresponding to the respective window to generate one or more sets of video space masks for the respective window, the one or more video clips representing the scene represented by the respective sample 4D point cloud, and
generating 4D point cloud masks for the respective window, the generating the 4D point cloud masks comprising lifting the one or more sets of video space masks from a video space to a 4D point cloud space corresponding to the 4D point cloud; and
generating the target labels, the generating the target labels comprising correlating 4D point cloud masks for single object instances across the multiple windows.

17. The system of claim 16, wherein the performing, for each respective window of multiple windows of the plurality of overlapping windows further comprises extracting semantic features for one or more video space masks of the one or more sets of video space masks for the respective window, and
wherein the target labels include embedding vectors corresponding to single object instances formed by averaging extracted semantic features across the multiple windows.

18. The system of claim 17, wherein the one or more neural networks comprise a 4D encoder-decoder network to process 4D point clouds and produce feature tensors; and
a transformer decoder to process learnable queries, based on the feature tensors, to generate the predicted labels.

19. One or more processors comprising:
one or more arithmetic logic units (ALUs) to train one or more neural networks, at least in part, by:
obtaining sample 4D point clouds, each respective sample 4D point cloud representing a respective scene for a respective period;
labeling the sample 4D point clouds with target labels; and
training a panoptic 4D segmentation model by performing, for one or more training iterations:
generating predicted labels using the one or more neural networks based on a sample 4D point cloud,
computing one or more losses based on the predicted labels and the target labels, and
updating, based on the one or more losses, parameters of the one or more neural networks.

20. The one or more processors of claim 19, wherein the labeling the sample 4D point clouds with target labels comprises, for a respective sample 4D point cloud:
temporally partitioning the 4D point cloud into a plurality of overlapping windows;
performing, for each respective window of multiple windows of the plurality of overlapping windows:
segmenting one or more video clips corresponding to the respective window to generate one or more sets of video space masks for the respective window, the one or more video clips representing the scene represented by the respective sample 4D point cloud, and
generating 4D point cloud masks for the respective window, the generating the 4D point cloud masks comprising lifting the one or more sets of video space masks from a video space to a 4D point cloud space corresponding to the 4D point cloud; and
generating the target labels, the generating the target labels comprising correlating 4D point cloud masks for single object instances across the multiple windows.
